(19) United States
(12) Patent Application Publication
(10) Pub. No.: US 2025/0270379 A1
(43) Pub. Date: Aug. 28, 2025

(54) EXPANDABLE THERMOPLASTIC PELLETS AND FOAMS AND METHODS OF FOAMING USING SAME

(71) Applicant: HONEYWELL INTERNATIONAL INC., Charlotte, NC (US)

(72) Inventors: Syed Hassan Mahmood, Charlotte, NC (US); Josep Gimeno, Charlotte, NC (US)

(73) Assignee: HONEYWELL INTERNATIONAL INC., Charlotte, NC (US)

(21) Appl. No.: 19/054,540

(22) Filed: Feb. 14, 2025

Related U.S. Application Data
(60) Provisional application No. 63/558,967, filed on Feb. 28, 2024.

(51) Int. Cl. C08J 9/18; C08J 9/14

(52) U.S. Cl. CPC C08J 9/18; C08J 9/141; C08J 9/147; C08J 2203/14; C08J 2203/164; C08J 2205/052; C08J 2325/06

(57) ABSTRACT

Methods of making thermoplastic foam comprising: immersing a plurality of thermoplastic pellets comprising at least about 50% by weight of polystyrene in a physical blowing agent bath containing from greater than about 50% by weight to less than about 90% by weight of pentane; and from greater than about 10% by weight to less than about 50% by weight of HFCO-1233zd(E) to produce a plurality of expandable pellets; and using the expandable pellets for form foam.

### CROSS REFERENCE TO RELATED APPLICATION

This application is related to and claims the priority benefit of U.S. Provisional Application No. 63/558,967, filed Feb. 28, 2024, which is incorporated by reference herein in its entirety.

### FIELD OF THE INVENTION

This invention relates to expandable thermoplastic particles, to foam products made from such particles (including molded foam products) and to methods of making foam (including molded foam) using such particles. The present invention includes expandable thermoplastic particles, especially polystyrene particles, which are able to maintain high expandability and to the use of same to form foam products having advantageously low density.

### BACKGROUND

It is known to impregnate thermoplastic particles, including polystyrene particles, with a volatile physical blowing agent, such as propane, butane or pentane, to produce expandable polystyrene (EPS) particles (also sometimes referred to herein as EPS pellets) that have the ability to foam. In general, it is highly desirable for EPS pellets to have the ability to retain high loadings of the blowing agent, including during periods of storage. When ready for processing, the EPS pellets are softened and joined together (usually by heating in a mold), and the blowing agent expands the pellets into a cellular polymer structure.

Foaming of multiple expanded polymeric pellets in a constrained mold is useful for preparing polystyrene foam structures comprising multiple expanded polymer foam pellets fused to one another and forming a foam block, slab or other shapes in the mold.

One common method for impregnating blowing agent into the pellets is to expose the pellets to blowing agent under pressure and for a sufficient time to allow the blowing agent to penetrate into (that is, impregnate) the polymeric pellets.

U.S. Pat. No. 5,561,170, for example, discloses a method for preparing expandable thermoplastic polymer pellets by impregnating the pellets with blowing agent in an aqueous suspension. Impregnation of blowing agent in U.S. Pat. No. 5,561,170 occurs by exposing 100 weight-parts polystyrene particles to 6.6 weight-parts pentane for nearly eight hours-four hours at a temperature that is increasing from 108° C. to 125° C. and another four hours at 125° C.

While it is important to impregnate the EPS pellets with the amount of blowing agent necessary to achieve the desired level of foaming and foam properties, it is a potential problem of such EPS pellets that the blowing agent is not sufficiently retained in the pellets after they are formed. Such a result is problematic because the blowing agent which leaves the pellet is thus not available to achieve the desired level of foaming. It is possible to counter this problem by attempting to increase the amount of blowing agent that is initially impregnated, but this possible solution has numerous disadvantages, including increasing the cost, complexity and time required to produce the EPS pellets. On the other hand, if foaming is allowed to proceed with unacceptably reduced levels of blowing agent, a deterioration in foam properties can occur, including the production of foams with a density that is higher than desirable.

It has become increasingly desirable to use blowing agents having low or even zero ozone depletion potential, such as certain hydrofluorocarbons (“HFCs”). However, some HFC fluids may have relatively high global warming potentials, and it is desirable to use hydrofluorocarbons or other fluorinated fluids having low ozone depletion potential and low global warming potential while maintaining the desired performance properties of the foam.

In terms of performance properties of the foam, it is considered important in many cases that the foam possess excellent properties, including in many applications relatively low density. For example, there is a need in many foam applications to have a foam that has a relatively low foam density, and also possibly low thermal conductivity. A significant challenge has been encountered in efforts to achieve thermoplastic foams that have low density and other desirable properties for the application. For example, for some preferred thermal insulating applications, the foam should at once have low thermal conductivity and low density, and in particular it is desirable in many applications to achieve thermoplastic polystyrene foam with a density of about 30 kg/m3 or less and at the same time a thermal conductivity of about 35 mW/mK or less.

There has thus been an increasing need for new blowing agent materials that are attractive alternatives to the compositions heretofore used as blowing agents in these and other applications. Applicants have thus recognized a need for new blowing agent compositions that offer effective alternatives to, and are considered environmentally safer substitutes for, previously used blowing agents to make low density foams, and to low density, low thermal conductivity thermoplastic foams, and to pellet-based polystyrene foam in particular.

Applicants have come to appreciate that an unexpected advantage can be achieved in connection with the formation of such thermoplastic foams from expandable thermoplastic pellets, and in particular to molded foams made from EPS particles, by using a carefully selected combination of blowing agent components in carefully selected amounts, as explained in detail hereinafter.

### SUMMARY

The present invention includes methods of making thermoplastic foam comprising:
(a) impregnating a plurality of thermoplastic pellets comprising at least about 50% by weight of polystyrene with a physical blowing agent by:
   a. immersing said plurality of pellets in a bath comprising a physical blowing agent to produce a plurality of expandable pellets, said physical blowing agent comprising, based on the total weight of the physical blowing agent in said bath:
      i. from greater than about 50% by weight to less than about 90% by weight of pentane; and
      ii. from greater than about 10% by weight to less than about 50% by weight of HFCO-1233zd(E);
(b) expanding said expandable pellets to produce expanded pellets; and
(c) forming foam by joining said expanded pellets.
   For the purposes of convenience, foam forming methods in accordance with this paragraph are referred to herein as Foam Forming Method 1A.

The present invention includes methods of making molded thermoplastic foam comprising:
(a) impregnating a plurality of thermoplastic pellets comprising at least about 50% by weight of polystyrene with a physical blowing agent by:
   a. immersing said plurality of pellets in a bath comprising a physical blowing agent to produce a plurality of expandable pellets, said physical blowing agent comprising, based on the total weight of the physical blowing agent in said bath:
      i. from greater than about 50% by weight to less than about 90% by weight of pentane; and
      ii. from greater than about 10% by weight to less than about 50% by weight of HFCO-1233zd(E);
(b) expanding said expandable pellets to produce expanded pellets;
(c) introducing said expanded pellets into a mold; and
(d) forming foam in said mold.
   For the purposes of convenience, foam forming methods in accordance with this paragraph are referred to herein as Foam Forming Method 1B.

The present invention includes methods of making molded thermoplastic foam comprising:
(a) impregnating a plurality of thermoplastic pellets comprising at least about 50% by weight of polystyrene with a physical blowing agent by:
   a. immersing said plurality of pellets in a bath comprising a physical blowing agent to produce a plurality of expandable pellets, said physical blowing agent comprising, based on the total weight of the physical blowing agent in said bath:
      iii. from greater than about 50% by weight to less than about 90% by weight of pentane; and
      iv. from greater than about 10% by weight to less than about 50% by weight of HFCO-1233zd(E);
(b) expanding said expandable pellets to produce expanded pellets having a density of not greater than 45 kg/m³;
(c) introducing said expanded pellets into a mold; and
(d) forming foam in said mold.
   For the purposes of convenience, foam forming methods in accordance with this paragraph are referred to herein as Foam Forming Method 1C.

The present invention includes methods of making molded thermoplastic foam comprising:
(a) impregnating a plurality of thermoplastic pellets comprising at least about 50% by weight of polystyrene with a physical blowing agent by:
   a. immersing said plurality of pellets in a bath comprising a physical blowing agent to produce a plurality of expandable pellets, said physical blowing agent comprising, based on the total weight of the physical blowing agent in said bath:
      i. from greater than about 50% by weight to less than about 90% by weight of pentane; and
      ii. from greater than about 10% by weight to less than about 50% by weight of HFCO-1233zd(E);
(b) expanding said expandable pellets to produce expanded pellets which:
   (i) comprise an amount of pentane on a weight basis that is not more than 20 relative percent less than the amount of pentane present when physical blowing agent consisting of said pentane is used in said process; and (ii) having a density of not greater than 45 kg/m³;
(c) introducing said expanded pellets into a mold; and
(d) forming foam in said mold.
   For the purposes of convenience, foam forming methods in accordance with this paragraph are referred to herein as Foam Forming Method 1D.

The present invention includes methods of making molded thermoplastic foam comprising:
(a) impregnating a plurality of thermoplastic pellets comprising at least about 50% by weight of polystyrene with a physical blowing agent by:
   a. immersing said plurality of pellets in a bath comprising a physical blowing agent to produce a plurality of expandable pellets, said physical blowing agent comprising, based on the total weight of the physical blowing agent in said bath:
      i. from greater than about 50% by weight to less than about 90% by weight of pentane; and
      ii. from greater than about 10% by weight to less than about 50% by weight of HFCO-1233zd(E);
(b) expanding said expandable pellets to produce expanded pellets which:
   (i) comprise an amount of pentane on a weight basis that is not more than 10 relative percent less than the amount of pentane present when physical blowing agent consisting of said pentane is used in said process; and (ii) having a density of not greater than 45 kg/m³;
(c) introducing said expanded pellets into a mold; and
(d) forming foam in said mold.
   For the purposes of convenience, foam forming methods in accordance with this paragraph are referred to herein as Foam Forming Method 1E.

The present invention includes methods of making molded thermoplastic foam comprising:
(a) impregnating a plurality of thermoplastic pellets comprising at least about 50% by weight of polystyrene with a physical blowing agent by:
   a. immersing said plurality of pellets in a bath comprising a physical blowing agent to produce a plurality of expandable pellets, said physical blowing agent comprising, based on the total weight of the physical blowing agent in said bath:
      i. from greater than about 50% by weight to less than about 90% by weight of pentane; and
      ii. from greater than about 10% by weight to less than about 50% by weight of HFCO-1233zd(E),
   wherein said expandable pellets comprise not less than 5% by weight of said pentane and not less than 1% by weight of HFCO-1233zd(E);
(b) expanding said expandable pellets to produce expanded pellets which:
   (i) comprise not less than 2 percent on a weight basis of said pentane; and (ii) having a density of not greater than 45 kg/m³;
(c) introducing said expanded pellets into a mold; and
(d) forming foam in said mold.
   For the purposes of convenience, foam forming methods in accordance with this paragraph are referred to herein as Foam Forming Method 1F.

The present invention includes methods of making molded thermoplastic foam comprising:
(a) impregnating a plurality of thermoplastic pellets comprising at least about 50% by weight of polystyrene with a physical blowing agent by:
   a. immersing said plurality of pellets in a bath comprising a physical blowing agent to produce a plurality of expandable pellets, said physical blowing agent comprising, based on the total weight of the physical blowing agent in said bath:
      i. from greater than about 50% by weight to less than about 90% by weight of pentane; and
      ii. from greater than about 10% by weight to less than about 50% by weight of HFCO-1233zd(E);
(b) expanding said expandable pellets to produce expanded pellets which:
(c) introducing said expanded pellets into a mold; and
(d) forming in said mold a foam having a density of not greater than 25 kg/m³.
   For the purposes of convenience, foam forming methods in accordance with this paragraph are referred to herein as Foam Forming Method 1G.

The present invention includes methods of making thermoplastic foam comprising:
(a) impregnating a plurality of thermoplastic pellets comprising at least about 50% by weight of polystyrene with a physical blowing agent by:
   a. immersing said plurality of pellets in a bath comprising a physical blowing agent to produce a plurality of expandable pellets, said physical blowing agent comprising, based on the total weight of the physical blowing agent in said bath:
      i. from greater than about 50% by weight to less than about 90% by weight of pentane; and
      ii. from greater than about 10% by weight to less than about 50% by weight of HFCO-1233zd(E);
(b) expanding said expandable pellets to produce expanded pellets;
(c) storing said expanded pellets for a period of at least 13 days; and
(d) forming foam by joining said expanded pellets.
   For the purposes of convenience, foam forming methods in accordance with this paragraph are referred to herein as Foam Forming Method 2A.

The present invention includes methods of making molded thermoplastic foam comprising:
(e) impregnating a plurality of thermoplastic pellets comprising at least about 50% by weight of polystyrene with a physical blowing agent by:
   a. immersing said plurality of pellets in a bath comprising a physical blowing agent to produce a plurality of expandable pellets, said physical blowing agent comprising, based on the total weight of the physical blowing agent in said bath:
      i. from greater than about 50% by weight to less than about 90% by weight of pentane; and
      ii. from greater than about 10% by weight to less than about 50% by weight of HFCO-1233zd(E);
(f) expanding said expandable pellets to produce expanded pellets;
(g) storing said expanded pellets for a period of at least 13 days;
(h) introducing said expanded pellets into a mold; and
(i) forming foam in said mold.
   For the purposes of convenience, foam forming methods in accordance with this paragraph are referred to herein as Foam Forming Method 2B.

The present invention includes methods of making molded thermoplastic foam comprising:
(a) impregnating a plurality of thermoplastic pellets comprising at least about 50% by weight of polystyrene with a physical blowing agent by:
   a. immersing said plurality of pellets in a bath comprising a physical blowing agent to produce a plurality of expandable pellets, said physical blowing agent comprising, based on the total weight of the physical blowing agent in said bath:
      i. from greater than about 50% by weight to less than about 90% by weight of pentane; and
      ii. from greater than about 10% by weight to less than about 50% by weight of HFCO-1233zd(E);
(b) expanding said expandable pellets to produce expanded pellets having a density of not greater than 45 kg/m³;
(c) storing said expanded pellets for a period of at least 13 days;
(d) after said storage step, introducing said expanded pellets into a mold; and
(e) forming foam in said mold.
   For the purposes of convenience, foam forming methods in accordance with this paragraph are referred to herein as Foam Forming Method 2C.

The present invention includes methods of making molded thermoplastic foam comprising:
(a) impregnating a plurality of thermoplastic pellets comprising at least about 50% by weight of polystyrene with a physical blowing agent by:
   a. immersing said plurality of pellets in a bath comprising a physical blowing agent to produce a plurality of expandable pellets, said physical blowing agent comprising, based on the total weight of the physical blowing agent in said bath:
      i. from greater than about 50% by weight to less than about 90% by weight of pentane; and
      ii. from greater than about 10% by weight to less than about 50% by weight of HFCO-1233zd(E);
(b) expanding said expandable pellets to produce expanded pellets;
(c) storing said expanded pellets for a period of at least 13 days, wherein said stored, expanded pellets: (i) comprise an amount of pentane on a weight basis that is not more than 20 relative percent less than the amount of pentane present when physical blowing agent consisting of said pentane is used in said process; and (ii) have a density of not greater than 45 kg/m³;
(d) after said storage step, introducing said expanded pellets into a mold; and
(e) forming foam in said mold.
   For the purposes of convenience, foam forming methods in accordance with this paragraph are referred to herein as Foam Forming Method 2D.

The present invention includes methods of making molded thermoplastic foam comprising:
(a) impregnating a plurality of thermoplastic pellets comprising at least about 50% by weight of polystyrene with a physical blowing agent by:
   a. immersing said plurality of pellets in a bath comprising a physical blowing agent to produce a plurality of expandable pellets, said physical blowing agent comprising, based on the total weight of the physical blowing agent in said bath:
      i. from greater than about 50% by weight to less than about 90% by weight of pentane; and
      ii. from greater than about 10% by weight to less than about 50% by weight of HFCO-1233zd(E);
(b) expanding said expandable pellets to produce expanded pellets;
(c) storing said expanded pellets for a period of at least 13 days, wherein after said storage step said expanded pellets: (i) comprise an amount of pentane on a weight basis that is not more than 10 relative percent less than the amount of pentane present when physical blowing agent consisting of said pentane is used in said process; and (ii) have a density of not greater than 45 kg/m³;
(d) introducing said expanded pellets into a mold; and
(e) forming foam in said mold.
For the purposes of convenience, foam forming methods in accordance with this paragraph are referred to herein as Foam Forming Method 2E.

The present invention includes methods of making molded thermoplastic foam comprising:
(a) impregnating a plurality of thermoplastic pellets comprising at least about 50% by weight of polystyrene with a physical blowing agent by:
   a. immersing said plurality of pellets in a bath comprising a physical blowing agent to produce a plurality of expandable pellets, said physical blowing agent comprising, based on the total weight of the physical blowing agent in said bath:
      i. from greater than about 50% by weight to less than about 90% by weight of pentane; and
      ii. from greater than about 10% by weight to less than about 50% by weight of HFCO-1233zd(E),
   wherein said expandable pellets comprise not less than 5% by weight of said pentane and not less than 1% by weight of HFCO-1233zd(E);
(b) expanding said expandable pellets to produce expanded pellets;
(c) storing said expanded pellets for a period of at least 13 days, wherein after said storage step said expanded pellets: (i) comprise not less than 2 percent on a weight basis of said pentane; and (ii) having a density of not greater than 45 kg/m³;
(d) introducing said expanded pellets into a mold; and
(e) forming foam in said mold.
   For the purposes of convenience, foam forming methods in accordance with this paragraph are referred to herein as Foam Forming Method 2F.

The present invention includes methods of making molded thermoplastic foam comprising:
(a) impregnating a plurality of thermoplastic pellets comprising at least about 50% by weight of polystyrene with a physical blowing agent by:
   a. immersing said plurality of pellets in a bath comprising a physical blowing agent to produce a plurality of expandable pellets, said physical blowing agent comprising, based on the total weight of the physical blowing agent in said bath:
      i. from greater than about 50% by weight to less than about 90% by weight of pentane; and
      ii. from greater than about 10% by weight to less than about 50% by weight of HFCO-1233zd(E),
   wherein said expandable pellets comprise not less than 5% by weight of said pentane and not less than 1% by weight of HFCO-1233zd(E);
(b) expanding said expandable pellets to produce expanded pellets;
(c) storing said expanded pellets for a period of at least 13 days;
(d) introducing said expanded pellets into a mold; and
(e) forming in said mold a foam having a density of not greater than 25 kg/m³.
   For the purposes of convenience, foam forming methods in accordance with this paragraph are referred to herein as Foam Forming Method 2G.

The present invention includes methods of making thermoplastic foam comprising:
(a) proving a plurality of expandable thermoplastic pellets wherein said thermoplastic comprises at least about 50% by weight of polystyrene and wherein said pellets include a physical blowing agent comprising not less than 5% by weight of said pentane and not less than 1% by weight of HFCO-1233zd(E):
(b) expanding said expandable pellets to produce expanded pellets; and
(c) forming a foam by joining said expanded pellets, wherein said foam has a density of not greater than 25 kg/m³.
   For the purposes of convenience, foam forming methods in accordance with this paragraph are referred to herein as Foam Forming Method 3A.

The present invention includes methods of making molded thermoplastic foam comprising:
(a) proving a plurality of expandable thermoplastic pellets wherein said thermoplastic comprises at least about 50% by weight of polystyrene and wherein said pellets include a physical blowing agent comprising not less than 5% by weight of said pentane and not less than 1% by weight of HFCO-1233zd(E):
(b) expanding said expandable pellets to produce expanded pellets; and
(c) forming in a mold a foam having a density of not greater than 25 kg/m³.
   For the purposes of convenience, foam forming methods in accordance with this paragraph are referred to herein as Foam Forming Method 3B.

The present invention includes methods of making molded thermoplastic foam comprising:
(a) proving a plurality of expandable thermoplastic pellets wherein said thermoplastic comprises at least about 50% by weight of polystyrene and wherein said pellets include a physical blowing agent comprising not less than 5% by weight of said pentane and not less than 1% by weight of HFCO-1233zd(E):
(b) expanding said expandable pellets to produce expanded pellets; and
(c) forming a foam in a molding by joining said expanded pellets to form molded foam, wherein said molded foam has a density of not greater than 25 kg/m³.
   For the purposes of convenience, foam forming methods in accordance with this paragraph are referred to herein as Foam Forming Method 3C.

The present invention includes expandable thermoplastic pellets comprising:
(a) at least about 50% by weight of polystyrene; and
(b) a physical blowing agent comprising, based on the total weight of the physical blowing agent in said expandable pellets:
   i. from greater than 2.5% to about 6.5% by weight of pentane; and
   ii. greater than 1% by weight to less than about 3% by weight of HFCO-1233zd(E).
      For the purposes of convenience, expandable pellets in accordance with this paragraph are referred to herein as Expandable Pellets 1.

The present invention includes expanded thermoplastic pellets comprising:
(a) at least about 50% by weight of polystyrene; and
(b) a physical blowing agent comprising, based on the total weight of the physical blowing agent in said expanded pellets:
   i. from greater than 1.5 to about 3.5% by weight of pentane; and
   ii. greater than 1% by weight to less than about 2% by weight of HFCO-1233zd(E).
      For the purposes of convenience, expanded pellets in accordance with this paragraph are referred to herein as Expanded Pellets 1A.

The present invention includes expanded thermoplastic pellets comprising:
(a) at least about 50% by weight of polystyrene; and
(b) a physical blowing agent comprising, based on the total weight of the physical blowing agent in said expanded pellets:
   i. from greater than 1.5 to about 3.5% by weight of pentane; and
   ii. greater than 1% by weight to less than about 2% by weight of HFCO-1233zd(E),
      wherein said expanded pellets have a density of not greater than 45 kg/m³. For the purposes of convenience, expandable pellets in accordance with this paragraph are referred to herein as Expanded Pellets 1B.

The present invention includes expanded thermoplastic pellets comprising:
(a) at least about 50% by weight of polystyrene; and
(b) a physical blowing agent comprising pentane and HFCO-1233zd(E) impregnated in said expanded pellets, wherein said expanded pellets have a density of not greater than 45 kg/m³.
   For the purposes of convenience, expanded pellets in accordance with this paragraph are referred to herein as Expanded Pellets 1C.

The present invention includes expanded thermoplastic pellets comprising:
(c) at least about 50% by weight of polystyrene; and
(d) a physical blowing agent comprising pentane and HFCO-1233zd(E) impregnated in said expanded pellets, wherein said expanded pellets have a density of not greater than 40 kg/m³.
   For the purposes of convenience, expanded pellets in accordance with this paragraph are referred to herein as Expanded Pellets 1D.

The present invention includes closed cell thermoplastic foam comprising:
(a) a plurality of closed cells comprising cell walls formed by a plurality of joined thermoplastic pellets, wherein said thermoplastic comprises at least about 50% by weight of polystyrene; and
(b) a physical blowing agent contained within said closed cells and comprising, based on the total weight of the foam:
   i. greater than 1.5% by weight of pentane; and
   ii. not less than 1% by weight of HFCO-1233zd(E).
      For the purposes of convenience, foam in accordance with this paragraph are referred to herein as Foam 1A.

The present invention includes closed cell thermoplastic foam comprising:
(a) a plurality of closed cells comprising cell walls formed by a plurality joined thermoplastic pellets, wherein said thermoplastic comprises at least about 50% by weight of polystyrene; and
(b) a physical blowing agent contained within said closed cells and comprising, based on the total weight of the foam:
   i. greater than 1.5% by weight of pentane; and
   ii. not less than 1% by weight of HFCO-1233zd(E),
      wherein said foam has a density of not greater than 40 kg/m³. For the purposes of convenience, foam in accordance with this paragraph are referred to herein as Foam 1B.

The present invention includes closed cell thermoplastic foam comprising:
(a) a plurality of closed cells comprising cell walls formed by a plurality joined thermoplastic pellets, wherein said thermoplastic comprises at least about 50% by weight of polystyrene; and
(b) a physical blowing agent contained within said closed cells and comprising, based on the total weight of the foam:
   i. greater than 1.5% by weight of pentane; and
   ii. not less than 1% by weight of HFCO-1233zd(E),
      wherein said foam has a density of not greater than 40 kg/m³ and thermal conductivity of not greater than 35 mW/mK.
      For the purposes of convenience, foam in accordance with this paragraph are referred to herein as Foam 1C.

The present invention includes closed cell thermoplastic foam comprising:
(a) a plurality of closed cells comprising cell walls formed by a plurality joined thermoplastic pellets, wherein said thermoplastic comprises at least about 50% by weight of polystyrene; and
(b) a physical blowing agent comprising pentane and HFCO-1233zd(E) contained within said closed cells, wherein said foam has a density of not greater than 40 kg/m³ and thermal conductivity of not greater than 35 mW/mK.
   For the purposes of convenience, foam in accordance with this paragraph are referred to herein as Foam 1D.

### DEFINITIONS

The term HFCO-1233zd(E) means the trans isomer of 1-chloro-3,3,3-trifluoropropene.

Closed cell foam means that a substantial volume percentage of the cells in the foam are closed, for example, about 20% by volume or more.

Styrene moiety means the compounds having the structure

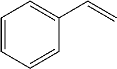

and all compounds in which one or more of the hydrogens are substituted.

Polystyrene, polystyrene resin, and PS each mean a polymer that is made from monomers that includes the styrene moiety, including homopolymers thereof, copolymers, and blends of polymers that include such homopolymers and/or copolymers.

Thermal conductivity means thermal conductivity measured as described in the examples.

The terms “melt flow index” and “MFI” mean the values of a thermoplastic polymer as measured in accordance with ISO 1133 in grams per 10 minutes.

Density means density as measured by ASTM D792-20.

As used herein, reference to a defined group, such as “Foam Forming Method 1-3,” refers to each method within that group, including wherein a definition number includes a suffix. For example, reference to Foam Forming Method 2-3 includes reference to each of Foam Forming Method 2A, Foam Forming Method 2B, Foam Forming Method 2C, Foam Forming Method 2D, Foam Forming Method 2E and Foam Forming Method 2F, Foam Forming Method 2G, Foam Forming Method 3A, Foam Forming Method 3B, and Foam Forming Method 3C.

### DETAILED DESCRIPTION

### Expandable Pellets

The present invention includes expandable thermoplastic pellets, including Expandable Pellets 1, in which at least about 50% by weight of thermoplastic is polystyrene and which contain within the pellets a physical blowing agent comprising, consisting essentially of or consist of pentane and HFCO-1233zd(E). In preferred embodiments the expandable pellets of the present invention are further limited as indicated in the Expandable Pellet Table below, with each expandable pellet being named in the first column as by an Expandable Pellet No., and reference herein to an Expandable Pellet by that number is understood to incorporate all of the limitations described in the row corresponding to that Expandable Pellet number.

EXPANDABLE PELLET TABLE

| | Thermoplastic | | Blowing Agent | | |
|---|---|---|---|---|---|
| | MFI, | | | | HFCO- |
| Expandable | gm/10 | wt. % | Pentane | | 1233zd(E) |
| Pellet No. | min | PS | Isomer | Wt. % | Wt. % |
| 2A1 | NR | =>50 | NR | >2.5-<6 | >1-<4.5 |
| 2A2 | NR | =>50 | n-pentane | >2.5-<6 | >1-<4.5 |
| 2A3 | NR | =>50 | NR | >3-<6 | >1.2-<4 |
| 2A4 | NR | =>50 | n-pentane | >3-<6 | >1.2-<4 |
| 2A5 | NR | =>50 | NR | >3.5-<6 | >1.3-<4 |
| 2A6 | NR | =>50 | n-pentane | >3.5-<6 | >1.3-<4 |
| 2A7 | NR | =>50 | NR | >3.5-<6 | >1.3-<3 |
| 2A8 | NR | =>50 | n-pentane | >3.5-<6 | >1.3-<3 |
| 2A9 | NR | =>50 | NR | >4.5-<6 | >1.3-<3 |
| 2A10 | NR | =>50 | n-pentane | >4.5-<6 | >1.3-<3 |
| 3A1 | NR | =>75 | NR | >2.5-<6 | >1-<4.5 |
| 3A2 | NR | =>75 | n-pentane | >2.5-<6 | >1-<4.5 |
| 3A3 | NR | =>75 | NR | >3-<6 | >1.2-<4 |
| 3A4 | NR | =>75 | n-pentane | >3-<6 | >1.2-<4 |
| 3A5 | NR | =>75 | NR | >3.5-<6 | >1.3-<4 |
| 3A6 | NR | =>75 | n-pentane | >3.5-<6 | >1.3-<4 |
| 3A7 | NR | =>75 | NR | >3.5-<6 | >1.3-<3 |
| 3A8 | NR | =>75 | n-pentane | >3.5-<6 | >1.3-<3 |
| 3A9 | NR | =>75 | NR | >4.5-<6 | >1.3-<3 |
| 3A10 | NR | =>75 | n-pentane | >4.5-<6 | >1.3-<3 |
| 4A1 | NR | =>85 | NR | >2.5-<6 | >1-<4.5 |
| 4A2 | NR | =>85 | n-pentane | >2.5-<6 | >1-<4.5 |
| 4A3 | NR | =>85 | NR | >3-<6 | >1.2-<4 |
| 4A4 | NR | =>85 | n-pentane | >3-<6 | >1.2-<4 |
| 4A5 | NR | =>85 | NR | >3.5-<6 | >1.3-<4 |
| 4A6 | NR | =>85 | n-pentane | >3.5-<6 | >1.3-<4 |
| 4A7 | NR | =>85 | NR | >3.5-<6 | >1.3-<3 |
| 4A8 | NR | =>85 | n-pentane | >3.5-<6 | >1.3-<3 |
| 4A9 | NR | =>85 | NR | >4.5-<6 | >1.3-<3 |
| 4A10 | NR | =>85 | n-pentane | >4.5-<6 | >1.3-<3 |
| 5A1 | NR | =>95 | NR | >2.5-<6 | >1-<4.5 |
| 5A2 | NR | =>95 | n-pentane | >2.5-<6 | >1-<4.5 |
| 5A3 | NR | =>95 | NR | >3-<6 | >1.2-<4 |
| 5A4 | NR | =>95 | n-pentane | >3-<6 | >1.2-<4 |
| 5A5 | NR | =>95 | NR | >3.5-<6 | >1.3-<4 |
| 5A6 | NR | =>95 | n-pentane | >3.5-<6 | >1.3-<4 |
| 5A7 | NR | =>95 | NR | >3.5-<6 | >1.3-<3 |
| 5A8 | NR | =>95 | n-pentane | >3.5-<6 | >1.3-<3 |
| 5A9 | NR | =>95 | NR | >4.5-<6 | >1.3-<3 |
| 5A10 | NR | =>95 | n-pentane | >4.5-<6 | >1.3-<3 |
| 6A1 | NR | =>99 | NR | >2.5-<6 | >1-<4.5 |
| 6A2 | NR | =>99 | n-pentane | >2.5-<6 | >1-<4.5 |
| 6A3 | NR | =>99 | NR | >3-<6 | >1.2-<4 |
| 6A4 | NR | =>99 | n-pentane | >3-<6 | >1.2-<4 |
| 6A5 | NR | =>99 | NR | >3.5-<6 | >1.3-<4 |
| 6A6 | NR | =>99 | n-pentane | >3.5-<6 | >1.3-<4 |
| 6A7 | NR | =>99 | NR | >3.5-<6 | >1.3-<3 |
| 6A8 | NR | =>99 | n-pentane | >3.5-<6 | >1.3-<3 |
| 6A9 | NR | =>99 | NR | >4.5-<6 | >1.3-<3 |
| 6A10 | NR | =>99 | n-pentane | >4.5-<6 | >1.3-<3 |
| 7A1 | =>3-=<20 | =>50 | NR | >2.5-<6 | >1-<4.5 |
| 7A2 | =>3-=<20 | =>50 | n-pentane | >2.5-<6 | >1-<4.5 |
| 7A3 | =>3-=<20 | =>50 | NR | >3-<6 | >1.2-<4 |
| 7A4 | =>3-=<20 | =>50 | n-pentane | >3-<6 | >1.2-<4 |
| 7A5 | =>3-=<20 | =>50 | NR | >3.5-<6 | >1.3-<4 |
| 7A6 | =>3-=<20 | =>50 | n-pentane | >3.5-<6 | >1.3-<4 |
| 7A7 | =>3-=<20 | =>50 | NR | >3.5-<6 | >1.3-<3 |
| 7A8 | =>3-=<20 | =>50 | n-pentane | >3.5-<6 | >1.3-<3 |
| 7A9 | =>3-=<20 | =>50 | NR | >4.5-<6 | >1.3-<3 |
| 7A10 | =>3-=<20 | =>50 | n-pentane | >4.5-<6 | >1.3-<3 |
| 8A1 | =>3-=<20 | =>75 | NR | >2.5-<6 | >1-<4.5 |
| 8A2 | =>3-=<20 | =>75 | n-pentane | >2.5-<6 | >1-<4.5 |
| 8A3 | =>3-=<20 | =>75 | NR | >3-<6 | >1.2-<4 |
| 8A4 | =>3-=<20 | =>75 | n-pentane | >3-<6 | >1.2-<4 |
| 8A5 | =>3-=<20 | =>75 | NR | >3.5-<6 | >1.3-<4 |
| 8A6 | =>3-=<20 | =>75 | n-pentane | >3.5-<6 | >1.3-<4 |
| 8A7 | =>3-=<20 | =>75 | NR | >3.5-<6 | >1.3-<3 |
| 8A8 | =>3-=<20 | =>75 | n-pentane | >3.5-<6 | >1.3-<3 |
| 8A9 | =>3-=<20 | =>75 | NR | >4.5-<6 | >1.3-<3 |
| 8A10 | =>3-=<20 | =>75 | n-pentane | >4.5-<6 | >1.3-<3 |
| 9A1 | =>3-=<20 | =>85 | NR | >2.5-<6 | >1-<4.5 |
| 9A2 | =>3-=<20 | =>85 | n-pentane | >2.5-<6 | >1-<4.5 |
| 9A3 | =>3-=<20 | =>85 | NR | >3-<6 | >1.2-<4 |
| 9A4 | =>3-=<20 | =>85 | n-pentane | >3-<6 | >1.2-<4 |
| 9A5 | =>3-=<20 | =>85 | NR | >3.5-<6 | >1.3-<4 |
| 9A6 | =>3-=<20 | =>85 | n-pentane | >3.5-<6 | >1.3-<4 |
| 9A7 | =>3-=<20 | =>85 | NR | >3.5-<6 | >1.3-<3 |
| 9A8 | =>3-=<20 | =>85 | n-pentane | >3.5-<6 | >1.3-<3 |
| 9A9 | =>3-=<20 | =>85 | NR | >4.5-<6 | >1.3-<3 |
| 9A10 | =>3-=<20 | =>85 | n-pentane | >4.5-<6 | >1.3-<3 |
| 10A1 | =>3-=<20 | =>95 | NR | >2.5-<6 | >1-<4.5 |
| 10A2 | =>3-=<20 | =>95 | n-pentane | >2.5-<6 | >1-<4.5 |
| 10A3 | =>3-=<20 | =>95 | NR | >3-<6 | >1.2-<4 |
| 10A4 | =>3-=<20 | =>95 | n-pentane | >3-<6 | >1.2-<4 |
| 10A5 | =>3-=<20 | =>95 | NR | >3.5-<6 | >1.3-<4 |
| 10A6 | =>3-=<20 | =>95 | n-pentane | >3.5-<6 | >1.3-<4 |
| 10A7 | =>3-=<20 | =>95 | NR | >3.5-<6 | >1.3-<3 |
| 10A8 | =>3-=<20 | =>95 | n-pentane | >3.5-<6 | >1.3-<3 |
| 10A9 | =>3-=<20 | =>95 | NR | >4.5-<6 | >1.3-<3 |
| 10A10 | =>3-=<20 | =>95 | n-pentane | >4.5-<6 | >1.3-<3 |
| 11A1 | =>3-=<20 | =>99 | NR | >2.5-<6 | >1-<4.5 |
| 11A2 | =>3-=<20 | =>99 | n-pentane | >2.5-<6 | >1-<4.5 |
| 11A3 | =>3-=<20 | =>99 | NR | >3-<6 | >1.2-<4 |
| 11A4 | =>3-=<20 | =>99 | n-pentane | >3-<6 | >1.2-<4 |
| 11A5 | =>3-=<20 | =>99 | NR | >3.5-<6 | >1.3-<4 |
| 11A6 | =>3-=<20 | =>99 | n-pentane | >3.5-<6 | >1.3-<4 |
| 11A7 | =>3-=<20 | =>99 | NR | >3.5-<6 | >1.3-<3 |
| 11A8 | =>3-=<20 | =>99 | n-pentane | >3.5-<6 | >1.3-<3 |
| 11A9 | =>3-=<20 | =>99 | NR | >4.5-<6 | >1.3-<3 |
| 11A10 | =>3-=<20 | =>99 | n-pentane | >4.5-<6 | >1.3-<3 |
| 12A1 | =>3-=<10 | =>50 | NR | >2.5-<6 | >1-<4.5 |
| 12A2 | =>3-=<10 | =>50 | n-pentane | >2.5-<6 | >1-<4.5 |
| 12A3 | =>3-=<10 | =>50 | NR | >3-<6 | >1.2-<4 |
| 12A4 | =>3-=<10 | =>50 | n-pentane | >3-<6 | >1.2-<4 |
| 12A5 | =>3-=<10 | =>50 | NR | >3.5-<6 | >1.3-<4 |
| 12A6 | =>3-=<10 | =>50 | n-pentane | >3.5-<6 | >1.3-<4 |
| 12A7 | =>3-=<10 | =>50 | NR | >3.5-<6 | >1.3-<3 |
| 12A8 | =>3-=<10 | =>50 | n-pentane | >3.5-<6 | >1.3-<3 |
| 12A9 | =>3-=<10 | =>50 | NR | >4.5-<6 | >1.3-<3 |
| 12A10 | =>3-=<10 | =>50 | n-pentane | >4.5-<6 | >1.3-<3 |
| 13A1 | =>2-=<10 | =>75 | NR | >2.5-<6 | >1-<4.5 |
| 13A2 | =>3-=<10 | =>75 | n-pentane | >2.5-<6 | >1-<4.5 |
| 13A3 | =>3-=<10 | =>75 | NR | >3-<6 | >1.2-<4 |
| 13A4 | =>3-=<10 | =>75 | n-pentane | >3-<6 | >1.2-<4 |
| 13A5 | =>3-=<10 | =>75 | NR | >3.5-<6 | >1.3-<4 |
| 13A6 | =>3-=<10 | =>75 | n-pentane | >3.5-<6 | >1.3-<4 |
| 13A7 | =>3-=<10 | =>75 | NR | >3.5-<6 | >1.3-<3 |
| 13A8 | =>3-=<10 | =>75 | n-pentane | >3.5-<6 | >1.3-<3 |
| 13A9 | =>3-=<10 | =>75 | NR | >4.5-<6 | >1.3-<3 |
| 13A10 | =>3-=<10 | =>75 | n-pentane | >4.5-<6 | >1.3-<3 |
| 14A1 | =>3-=<10 | =>85 | NR | >2.5-<6 | >1-<4.5 |
| 14A2 | =>3-=<10 | =>85 | n-pentane | >2.5-<6 | >1-<4.5 |
| 14A3 | =>3-=<10 | =>85 | NR | >3-<6 | >1.2-<4 |
| 14A4 | =>3-=<10 | =>85 | n-pentane | >3-<6 | >1.2-<4 |
| 14A5 | =>3-=<10 | =>85 | NR | >3.5-<6 | >1.3-<4 |
| 14A6 | =>3-=<10 | =>85 | n-pentane | >3.5-<6 | >1.3-<4 |
| 14A7 | =>3-=<10 | =>85 | NR | >3.5-<6 | >1.3-<3 |
| 14A8 | =>3-=<10 | =>85 | n-pentane | >3.5-<6 | >1.3-<3 |
| 14A9 | =>3-=<10 | =>85 | NR | >4.5-<6 | >1.3-<3 |
| 14A10 | =>3-=<10 | =>85 | n-pentane | >4.5-<6 | >1.3-<3 |
| 15A1 | =>3-=<10 | =>95 | NR | >2.5-<6 | >1-<4.5 |
| 15A2 | =>3-=<10 | =>95 | n-pentane | >2.5-<6 | >1-<4.5 |
| 15A3 | =>3-=<10 | =>95 | NR | >3-<6 | >1.2-<4 |
| 15A4 | =>3-=<10 | =>95 | n-pentane | >3-<6 | >1.2-<4 |
| 15A5 | =>3-=<10 | =>95 | NR | >3.5-<6 | >1.3-<4 |
| 15A6 | =>3-=<10 | =>95 | n-pentane | >3.5-<6 | >1.3-<4 |
| 15A7 | =>3-=<10 | =>95 | NR | >3.5-<6 | >1.3-<3 |
| 15A8 | =>3-=<10 | =>95 | n-pentane | >3.5-<6 | >1.3-<3 |
| 15A9 | =>3-=<10 | =>95 | NR | >4.5-<6 | >1.3-<3 |
| 15A10 | =>3-=<10 | =>95 | n-pentane | >4.5-<6 | >1.3-<3 |
| 16A1 | =>3-=<10 | =>99 | NR | >2.5-<6 | >1-<4.5 |
| 16A2 | =>3-=<10 | =>99 | n-pentane | >2.5-<6 | >1-<4.5 |
| 16A3 | =>3-=<10 | =>99 | NR | >3-<6 | >1.2-<4 |
| 16A4 | =>3-=<10 | =>99 | n-pentane | >3-<6 | >1.2-<4 |
| 16A5 | =>3-=<10 | =>99 | NR | >3.5-<6 | >1.3-<4 |
| 16A6 | =>3-=<10 | =>99 | n-pentane | >3.5-<6 | >1.3-<4 |
| 16A7 | =>3-=<10 | =>99 | NR | >3.5-<6 | >1.3-<3 |
| 16A8 | =>3-=<10 | =>99 | n-pentane | >3.5-<6 | >1.3-<3 |
| 16A9 | =>3-=<10 | =>99 | NR | >4.5-<6 | >1.3-<3 |
| 16A10 | =>3-=<10 | =>99 | n-pentane | >4.5-<6 | >1.3-<3 |

In general it is contemplated that the average size and shape of the expandable pellets of the present invention may vary widely in accordance with shapes and sizes known to those skilled in the art, and all such shapes and sizes are within the scope of the present invention. Embodiments of the expandable pellets, including each of Expandable Pellets 1-16, include pellets which are generally spherical and/or disc-shaped and/or cylindrical and/or bead shaped. Embodiments of the expandable pellets include pellets which have an average particle size in the range of from about 0.2 mm to about 10 mm, or from 0.2 mm to about 5 mm, or from 0.2 mm to about 3 mm. Embodiments of the expandable pellets include pellets which are generally spherical and/or disc-shaped and/or cylindrical and have an average particle size in the range of from about 0.2 mm to about 10 mm, or from 0.2 mm to about 5 mm, or from 0.2 mm to about 3 mm.

### expanded Pellets

The present invention includes expanded thermoplastic pellets, including Expanded Pellets 1A-1D, wherein at least about 50% by weight of the thermoplastic is polystyrene and which contain within the expanded pellets a physical blowing agent comprising, consisting essentially of or consist of pentane and HFCO-1233zd(E). In preferred embodiments the expanded pellets of the present invention are further limited as indicated in the Expanded Pellet Table below, with each expanded pellet being named in the first column by an Expanded Pellet No., and reference herein to an Expanded Pellet by that number is understood to incorporate all of the limitations described in the row corresponding to that Expanded Pellet number.

EXPANDED PELLET TABLE

| Ex- | Thermoplastic | | | Blowing Agent | | | |
|---|---|---|---|---|---|---|---|
| panded | MFI, | wt. | | Pentane | | HFCO- | Pellet |
| Pellet | gm/10 | % | | | Wt. | 1233zd(E) | Density |
| No. | min | PS | Other | Isomer | % | Wt. % | kg/m³ |
| 2A1 | NR | =>50 | NR | NR | >1.5- | >1-<3 | =<40 |
| | | | | | <4 | | |
| 2A2 | NR | =>50 | NR | n- | >1.5- | >1-<2 | =<30 |
| | | | | pentane | <4 | | |
| 2A3 | NR | =>50 | NR | NR | >2-<4 | >1-<2.5 | =<30 |
| 2A4 | NR | =>50 | NR | n- | >2-<4 | >1-<2.5 | =<30 |
| | | | | pentane | | | |
| 2A5 | NR | =>50 | NR | NR | >2.5- | >1-<2.5 | =<30 |
| | | | | | <4 | | |
| 2A6 | NR | =>50 | NR | n- | >2.5- | >1-<2.5 | =<30 |
| | | | | pentane | <4 | | |
| 2A7 | NR | =>50 | NR | NR | >2.5- | >1.2-<2.0 | =<30 |
| | | | | | <4 | | |
| 2A8 | NR | =>50 | NR | n- | >2.5- | >1.2-<2.05 | =<30 |
| | | | | pentane | <4 | | |
| 2A9 | NR | =>50 | NR | NR | >2.5- | >1-<1.5 | =<30 |
| | | | | | <4 | | |
| 2A10 | NR | =>50 | NR | n- | >2.5- | >1-<1.5 | =<30 |
| | | | | pentane | <4 | | |
| 3A1 | NR | =>75 | NR | NR | >1.5- | >1-<3 | =<30 |
| | | | | | <4 | | |
| 3A2 | NR | =>75 | NR | n- | >1.5- | >1-<3 | =<30 |
| | | | | pentane | <4 | | |
| 3A3 | NR | =>75 | NR | NR | >2-<4 | >1-<2.5 | =<30 |
| 3A4 | NR | =>75 | NR | n- | >2-<4 | >1-<2.5 | =<30 |
| | | | | pentane | | | |
| 3A5 | NR | =>75 | NR | NR | >2.5- | >1-<2.5 | =<30 |
| | | | | | <4 | | |
| 3A6 | NR | =>75 | NR | n- | >2.5- | >1-<2.5 | =<30 |
| | | | | pentane | <4 | | |
| 3A7 | NR | =>75 | NR | NR | >2.5- | >1.2-<2.0 | =<30 |
| | | | | | <4 | | |
| 3A8 | NR | =>75 | NR | n- | >2.5- | >1.2-<2.05 | =<30 |
| | | | | pentane | <4 | | |
| 3A9 | NR | =>75 | NR | NR | >2.5- | >1-<1.5 | =<30 |
| | | | | | <4 | | |
| 3A10 | NR | =>75 | NR | n- | >2.5- | >1-<1.5 | =<30 |
| | | | | pentane | <4 | | |
| 4A1 | NR | =>85 | NR | NR | >1.5- | >1-<3 | =<30 |
| | | | | | <4 | | |
| 4A2 | NR | =>85 | NR | n- | >1.5- | >1-<3 | =<30 |
| | | | | pentane | <4 | | |
| 4A3 | NR | =>85 | NR | NR | >2-<4 | >1-<2.5 | =<30 |
| 4A4 | NR | =>85 | NR | n- | >2-<4 | >1-<2.5 | =<30 |
| | | | | pentane | | | |
| 4A5 | NR | =>85 | NR | NR | >2.5- | >1-<2.5 | =<30 |
| | | | | | <4 | | |
| 4A6 | NR | =>85 | NR | n- | >2.5- | >1-<2.5 | =<30 |
| | | | | pentane | <4 | | |
| 4A7 | NR | =>85 | NR | NR | >2.5- | >1.2-<2.0 | =<30 |
| | | | | | <4 | | |
| 4A8 | NR | =>85 | NR | n- | >2.5- | >1.2-<2.05 | =<30 |
| | | | | pentane | <4 | | |
| 4A9 | NR | =>85 | NR | NR | >2.5- | >1-<1.5 | =<30 |
| | | | | | <4 | | |
| 4A10 | NR | =>85 | NR | n- | >2.5- | >1-<1.5 | =<30 |
| | | | | pentane | <4 | | |
| 5A1 | NR | =>95 | NR | NR | >1.5- | >1-<3 | =<30 |
| | | | | | <4 | | |
| 5A2 | NR | =>95 | NR | n- | >1.5- | >1-<3 | =<30 |
| | | | | pentane | <4 | | |
| 5A3 | NR | =>95 | NR | NR | >2-<4 | >1-<2.5 | =<30 |
| 5A4 | NR | =>95 | NR | n- | >2-<4 | >1-<2.5 | =<30 |
| | | | | pentane | | | |
| 5A5 | NR | =>95 | NR | NR | >2.5- | >1-<2.5 | =<30 |
| | | | | | <4 | | |
| 5A6 | NR | =>95 | NR | n- | >2.5- | >1-<2.5 | =<30 |
| | | | | pentane | <4 | | |
| 5A7 | NR | =>95 | NR | NR | >2.5- | >1.2-<2.0 | =<30 |
| | | | | | <4 | | |
| 5A8 | NR | =>95 | NR | n- | >2.5- | >1.2-<2.05 | =<30 |
| | | | | pentane | <4 | | |
| 5A9 | NR | =>95 | NR | NR | >2.5- | >1-<1.5 | =<30 |
| | | | | | <4 | | |
| 5A10 | NR | =>95 | NR | n- | >2.5- | >1-<1.5 | =<30 |
| | | | | pentane | <4 | | |
| 6A1 | NR | =>99 | NR | NR | >1.5- | >1-<3 | =<30 |
| | | | | | <4 | | |
| 6A2 | NR | =>99 | NR | n- | >1.5- | >1-<3 | =<30 |
| | | | | pentane | <4 | | |
| 6A3 | NR | =>99 | NR | NR | >2-<4 | >1-<2.5 | =<30 |
| 6A4 | NR | =>99 | NR | n- | >2-<4 | >1-<2.5 | =<30 |
| | | | | pentane | | | |
| 6A5 | NR | =>99 | NR | NR | >2.5- | >1-<2.5 | =<30 |
| | | | | | <4 | | |
| 6A6 | NR | =>99 | NR | n- | >2.5- | >1-<2.5 | =<30 |
| | | | | pentane | <4 | | |
| 6A7 | NR | =>99 | NR | NR | >2.5- | >1.2-<2.0 | =<30 |
| | | | | | <4 | | |
| 6A8 | NR | =>99 | NR | n- | >2.5- | >1.2-<2.05 | =<30 |
| | | | | pentane | <4 | | |
| 6A9 | NR | =>99 | NR | NR | >2.5- | >1-<1.5 | =<30 |
| | | | | | <4 | | |
| 6A10 | NR | =>99 | NR | n- | >2.5- | >1-<1.5 | =<30 |
| | | | | pentane | <4 | | |
| 7A1 | =>2- | =>50 | NR | NR | >1.5- | >1-<3 | =<30 |
| | =<28 | | | | <4 | | |
| 7A2 | =>2- | =>50 | NR | n- | >1.5- | >1-<3 | =<30 |
| | =<28 | | | pentane | <4 | | |
| 7A3 | =>2- | =>50 | NR | NR | >2-<4 | >1-<2.5 | =<30 |
| | =<28 | | | | | | |
| 7A4 | =>2- | =>50 | NR | n- | >2-<4 | >1-<2.5 | =<30 |
| | =<28 | | | pentane | | | |
| 7A5 | =>2- | =>50 | NR | NR | >2.5- | >1-<2.5 | =<30 |
| | =<28 | | | | <4 | | |
| 7A6 | =>2- | =>50 | NR | n- | >2.5- | >1-<2.5 | =<30 |
| | =<28 | | | pentane | <4 | | |
| 7A7 | =>2- | =>50 | NR | NR | >2.5- | >1.2-<2.0 | =<30 |
| | =<28 | | | | <4 | | |
| 7A8 | =>2- | =>50 | NR | n- | >2.5- | >1.2-<2.05 | =<30 |
| | =<28 | | | pentane | <4 | | |
| 7A9 | =>2- | =>50 | NR | NR | >2.5- | >1-<1.5 | =<30 |
| | =<28 | | | | <4 | | |
| 7A10 | =>2- | =>50 | NR | n- | >2.5- | >1-<1.5 | =<30 |
| | =<28 | | | pentane | <4 | | |
| 8A1 | =>2- | =>75 | NR | NR | >1.5- | >1-<3 | =<30 |
| | =<28 | | | | <4 | | |
| 8A2 | =>2- | =>75 | NR | n- | >1.5- | >1-<3 | =<30 |
| | =<28 | | | pentane | <4 | | |
| 8A3 | =>2- | =>75 | NR | NR | >2-<4 | >1-<2.5 | =<30 |
| | =<28 | | | | | | |
| 8A4 | =>2- | =>75 | NR | n- | >2-<4 | >1-<2.5 | =<30 |
| | =<28 | | | pentane | | | |
| 8A5 | =>2- | =>75 | NR | NR | >2.5- | >1-<2.5 | =<30 |
| | =<28 | | | | <4 | | |
| 8A6 | =>2- | =>75 | NR | n- | >2.5- | >1-<2.5 | =<30 |
| | =<28 | | | pentane | <4 | | |
| 8A7 | =>2- | =>75 | NR | NR | >2.5- | >1.2-<2.0 | =<30 |
| | =<28 | | | | <4 | | |
| 8A8 | =>2- | =>75 | NR | n- | >2.5- | >1.2-<2.05 | =<30 |
| | =<28 | | | pentane | <4 | | |
| 8A9 | =>2- | =>75 | NR | NR | >2.5- | >1-<1.5 | =<30 |
| | =<28 | | | | <4 | | |
| 8A10 | =>2- | =>75 | NR | n- | >2.5- | >1-<1.5 | =<30 |
| | =<28 | | | pentane | <4 | | |
| 9A1 | =>2- | =>85 | NR | NR | >1.5- | >1-<3 | =<30 |
| | =<28 | | | | <4 | | |
| 9A2 | =>2- | =>85 | NR | n- | >1.5- | >1-<3 | =<30 |
| | =<28 | | | pentane | <4 | | |
| 9A3 | =>2- | =>85 | NR | NR | >2-<4 | >1-<2.5 | =<30 |
| | =<28 | | | | | | |
| 9A4 | =>2- | =>85 | NR | n- | >2-<4 | >1-<2.5 | =<30 |
| | =<28 | | | pentane | | | |
| 9A5 | =>2- | =>85 | NR | NR | >2.5- | >1-<2.5 | =<30 |
| | =<28 | | | | <4 | | |
| 9A6 | =>2- | =>85 | NR | n- | >2.5- | >1-<2.5 | =<30 |
| | =<28 | | | pentane | <4 | | |
| 9A7 | =>2- | =>85 | NR | NR | >2.5- | >1.2-<2.0 | =<30 |
| | =<28 | | | | <4 | | |
| 9A8 | =>2- | =>85 | NR | n- | >2.5- | >1.2-<2.05 | =<30 |
| | =<28 | | | pentane | <4 | | |
| 9A9 | =>2- | =>85 | NR | NR | >2.5- | >1-<1.5 | =<30 |
| | =<28 | | | | <4 | | |
| 9A10 | =>2- | =>85 | NR | n- | >2.5- | >1-<1.5 | =<30 |
| | =<28 | | | pentane | <4 | | |
| 10A1 | =>2- | =>95 | NR | NR | >1.5- | >1-<3 | =<30 |
| | =<28 | | | | <4 | | |
| 10A2 | =>2- | =>95 | NR | n- | >1.5- | >1-<3 | =<30 |
| | =<28 | | | pentane | <4 | | |
| 10A3 | =>2- | =>95 | NR | NR | >2-<4 | >1-<2.5 | =<30 |
| | =<28 | | | | | | |
| 10A4 | =>2- | =>95 | NR | n- | >2-<4 | >1-<2.5 | =<30 |
| | =<28 | | | pentane | | | |
| 10A5 | =>2- | =>95 | NR | NR | >2.5- | >1-<2.5 | =<30 |
| | =<28 | | | | <4 | | |
| 10A6 | =>2- | =>95 | NR | n- | >2.5- | >1-<2.5 | =<30 |
| | =<28 | | | pentane | <4 | | |
| 10A7 | =>2- | =>95 | NR | NR | >2.5- | >1.2-<2.0 | =<30 |
| | =<28 | | | | <4 | | |
| 10A8 | =>2- | =>95 | NR | n- | >2.5- | >1.2-<2.05 | =<30 |
| | =<28 | | | pentane | <4 | | |
| 10A9 | =>2- | =>95 | NR | NR | >2.5- | >1-<1.5 | =<30 |
| | =<28 | | | | <4 | | |
| 10A10 | =>2- | =>95 | NR | n- | >2.5- | >1-<1.5 | =<30 |
| | =<28 | | | pentane | <4 | | |
| 11A1 | =>2- | =>99 | NR | NR | >1.5- | >1-<3 | =<30 |
| | =<28 | | | | <4 | | |
| 11A2 | =>2- | =>99 | NR | n- | >1.5- | >1-<3 | =<30 |
| | =<28 | | | pentane | <4 | | |
| 11A3 | =>2- | =>99 | NR | NR | >2-<4 | >1-<2.5 | =<30 |
| | =<28 | | | | | | |
| 11A4 | =>2- | =>99 | NR | n- | >2-<4 | >1-<2.5 | =<30 |
| | =<28 | | | pentane | | | |
| 11A5 | =>2- | =>99 | NR | NR | >2.5- | >1-<2.5 | =<30 |
| | =<28 | | | | <4 | | |
| 11A6 | =>2- | =>99 | NR | n- | >2.5- | >1-<2.5 | =<30 |
| | =<28 | | | pentane | <4 | | |
| 11A7 | =>2- | =>99 | NR | NR | >2.5- | >1.2-<2.0 | =<30 |
| | =<28 | | | | <4 | | |
| 11A8 | =>2- | =>99 | NR | n- | >2.5- | >1.2-<2.05 | =<30 |
| | =<28 | | | pentane | <4 | | |
| 11A9 | =>2- | =>99 | NR | NR | >2.5- | >1-<1.5 | =<30 |
| | =<28 | | | | <4 | | |
| 11A10 | =>2- | =>99 | NR | n- | >2.5- | >1-<1.5 | =<30 |
| | =<28 | | | pentane | <4 | | |
| 12A1 | =>2- | =>50 | NR | NR | >1.5- | >1-<3 | =<30 |
| | =<10 | | | | <4 | | |
| 12A2 | =>2- | =>50 | NR | n- | >1.5- | >1-<3 | =<30 |
| | =<10 | | | pentane | <4 | | |
| 12A3 | =>2- | =>50 | NR | NR | >2-<4 | >1-<2.5 | =<30 |
| | =<10 | | | | | | |
| 12A4 | =>2- | =>50 | NR | n- | >2-<4 | >1-<2.5 | =<30 |
| | =<10 | | | pentane | | | |
| 12A5 | =>2- | =>50 | NR | NR | >2.5- | >1-<2.5 | =<30 |
| | =<10 | | | | <4 | | |
| 12A6 | =>2- | =>50 | NR | n- | >2.5- | >1-<2.5 | =<30 |
| | =<10 | | | pentane | <4 | | |
| 12A7 | =>2- | =>50 | NR | NR | >2.5- | >1.2-<2.0 | =<30 |
| | =<10 | | | | <4 | | |
| 12A8 | =>2- | =>50 | NR | n- | >2.5- | >1.2-<2.05 | =<30 |
| | =<10 | | | pentane | <4 | | |
| 12A9 | =>2- | =>50 | NR | NR | >2.5- | >1-<1.5 | =<30 |
| | =<10 | | | | <4 | | |
| 12A10 | =>2- | =>50 | NR | n- | >2.5- | >1-<1.5 | =<30 |
| | =<10 | | | pentane | <4 | | |
| 13A1 | =>2- | =>75 | NR | NR | >1.5- | >1-<3 | =<30 |
| | =<10 | | | | <4 | | |
| 13A2 | =>2- | =>75 | NR | n- | >1.5- | >1-<3 | =<30 |
| | =<10 | | | pentane | <4 | | |
| 13A3 | =>2- | =>75 | NR | NR | >2-<4 | >1-<2.5 | =<30 |
| | =<10 | | | | | | |
| 13A4 | =>2- | =>75 | NR | n- | >2-<4 | >1-<2.5 | =<30 |
| | =<10 | | | pentane | | | |
| 13A5 | =>2- | =>75 | NR | NR | >2.5- | >1-<2.5 | =<30 |
| | =<10 | | | | <4 | | |
| 13A6 | =>2- | =>75 | NR | n- | >2.5- | >1-<2.5 | =<30 |
| | =<10 | | | pentane | <4 | | |
| 13A7 | =>2- | =>75 | NR | NR | >2.5- | >1.2-<2.0 | =<30 |
| | =<10 | | | | <4 | | |
| 13A8 | =>2- | =>75 | NR | n- | >2.5- | >1.2-<2.05 | =<30 |
| | =<10 | | | pentane | <4 | | |
| 13A9 | =>2- | =>75 | NR | NR | >2.5- | >1-<1.5 | =<30 |
| | =<10 | | | | <4 | | |
| 13A10 | =>2- | =>75 | NR | n- | >2.5- | >1-<1.5 | =<30 |
| | =<10 | | | pentane | <4 | | |
| 14A1 | =>2- | =>85 | NR | NR | >1.5- | >1-<3 | =<30 |
| | =<10 | | | | <4 | | |
| 14A2 | =>2- | =>85 | NR | n- | >1.5- | >1-<3 | =<30 |
| | =<10 | | | pentane | <4 | | |
| 14A3 | =>2- | =>85 | NR | NR | >2-<4 | >1-<2.5 | =<30 |
| | =<10 | | | | | | |
| 14A4 | =>2- | =>85 | NR | n- | >2-<4 | >1-<2.5 | =<30 |
| | =<10 | | | pentane | | | |
| 14A5 | =>2- | =>85 | NR | NR | >2.5- | >1-<2.5 | =<30 |
| | =<10 | | | | <4 | | |
| 14A6 | =>2- | =>85 | NR | n- | >2.5- | >1-<2.5 | =<30 |
| | =<10 | | | pentane | <4 | | |
| 14A7 | =>2- | =>85 | NR | NR | >2.5- | >1.2-<2.0 | =<30 |
| | =<10 | | | | <4 | | |
| 14A8 | =>2- | =>85 | NR | n- | >2.5- | >1.2-<2.05 | =<30 |
| | =<10 | | | pentane | <4 | | |
| 14A9 | =>2- | =>85 | NR | NR | >2.5- | >1-<1.5 | =<30 |
| | =<10 | | | | <4 | | |
| 14A10 | =>2- | =>85 | NR | n- | >2.5- | >1-<1.5 | =<30 |
| | =<10 | | | pentane | <4 | | |
| 15A1 | =>2- | =>95 | NR | NR | >1.5- | >1-<3 | =<30 |
| | =<10 | | | | <4 | | |
| 15A2 | =>2- | =>95 | NR | n- | >1.5- | >1-<3 | =<30 |
| | =<10 | | | pentane | <4 | | |
| 15A3 | =>2- | =>95 | NR | NR | >2-<4 | >1-<2.5 | =<30 |
| | =<10 | | | | | | |
| 15A4 | =>2- | =>95 | NR | n- | >2-<4 | >1-<2.5 | =<30 |
| | =<10 | | | pentane | | | |
| 15A5 | =>2- | =>95 | NR | NR | >2.5- | >1-<2.5 | =<30 |
| | =<10 | | | | <4 | | |
| 15A6 | =>2- | =>95 | NR | n- | >2.5- | >1-<2.5 | =<30 |
| | =<10 | | | pentane | <4 | | |
| 15A7 | =>2- | =>95 | NR | NR | >2.5- | >1.2-<2.0 | =<30 |
| | =<10 | | | | <4 | | |
| 15A8 | =>2- | =>95 | NR | n- | >2.5- | >1.2-<2.05 | =<30 |
| | =<10 | | | pentane | <4 | | |
| 15A9 | =>2- | =>95 | NR | NR | >2.5- | >1-<1.5 | =<30 |
| | =<10 | | | | <4 | | |
| 15A10 | =>2- | =>95 | NR | n- | >2.5- | >1-<1.5 | =<30 |
| | =<10 | | | pentane | <4 | | |
| 16A1 | =>2- | =>99 | NR | NR | >1.5- | >1-<3 | =<30 |
| | =<10 | | | | <4 | | |
| 16A2 | =>2- | =>99 | NR | n- | >1.5- | >1-<3 | =<30 |
| | =<10 | | | pentane | <4 | | |
| 16A3 | =>2- | =>99 | NR | NR | >2-<4 | >1-<2.5 | =<30 |
| | =<10 | | | | | | |
| 16A4 | =>2- | =>99 | NR | n- | >2-<4 | >1-<2.5 | =<30 |
| | =<10 | | | pentane | | | |
| 16A5 | =>2- | =>99 | NR | NR | >2.5- | >1-<2.5 | =<30 |
| | =<10 | | | | <4 | | |
| 16A6 | =>2- | =>99 | NR | n- | >2.5- | >1-<2.5 | =<30 |
| | =<10 | | | pentane | <4 | | |
| 16A7 | =>2- | =>99 | NR | NR | >2.5- | >1.2-<2.0 | =<30 |
| | =<10 | | | | <4 | | |
| 16A8 | =>2- | =>99 | NR | n- | >2.5- | >1.2-<2.05 | =<30 |
| | =<10 | | | pentane | <4 | | |
| 16A9 | =>2- | =>99 | NR | NR | >2.5- | >1-<1.5 | =<30 |
| | =<10 | | | | <4 | | |
| 16A10 | =>2- | =>99 | NR | n- | >2.5- | >1-<1.5 | =<30 |
| | =<10 | | | pentane | <4 | | |
| 17A1 | NR | =>50 | NR | NR | >1.5- | >1-<3 | NR |
| | | | | | <4 | | |
| 17A2 | NR | =>50 | NR | n- | >1.5- | >1-<3 | =<25 |
| | | | | pentane | <4 | | |
| 17A3 | NR | =>50 | NR | NR | >2-<4 | >1-<2.5 | =<25 |
| 17A4 | NR | =>50 | NR | n- | >2-<4 | >1-<2.5 | =<25 |
| | | | | pentane | | | |
| 17A5 | NR | =>50 | NR | NR | >2.5- | >1-<2.5 | =<25 |
| | | | | | <4 | | |
| 17A6 | NR | =>50 | NR | n- | >2.5- | >1-<2.5 | =<25 |
| | | | | pentane | <4 | | |
| 17A7 | NR | =>50 | NR | NR | >2.5- | >1.2-<2.0 | =<25 |
| | | | | | <4 | | |
| 17A8 | NR | =>50 | NR | n- | >2.5- | >1.2-<2.05 | =<25 |
| | | | | pentane | <4 | | |
| 17A9 | NR | =>50 | NR | NR | >2.5- | >1-<1.5 | =<25 |
| | | | | | <4 | | |
| 17A10 | NR | =>50 | NR | n- | >2.5- | >1-<1.5 | =<25 |
| | | | | pentane | <4 | | |
| 18A1 | NR | =>75 | NR | NR | >1.5- | >1-<3 | =<25 |
| | | | | | <4 | | |
| 18A2 | NR | =>75 | NR | n- | >1.5- | >1-<3 | =<25 |
| | | | | pentane | <4 | | |
| 18A3 | NR | =>75 | NR | NR | >2-<4 | >1-<2.5 | =<25 |
| 18A4 | NR | =>75 | NR | n- | >2-<4 | >1-<2.5 | =<25 |
| | | | | pentane | | | |
| 18A5 | NR | =>75 | NR | NR | >2.5- | >1-<2.5 | =<25 |
| | | | | | <4 | | |
| 18A6 | NR | =>75 | NR | n- | >2.5- | >1-<2.5 | =<25 |
| | | | | pentane | <4 | | |
| 18A7 | NR | =>75 | NR | NR | >2.5- | >1.2-<2.0 | =<25 |
| | | | | | <4 | | |
| 18A8 | NR | =>75 | NR | n- | >2.5- | >1.2-<2.05 | =<25 |
| | | | | pentane | <4 | | |
| 18A9 | NR | =>75 | NR | NR | >2.5- | >1-<1.5 | =<25 |
| | | | | | <4 | | |
| 18A10 | NR | =>75 | NR | n- | >2.5- | >1-<1.5 | =<25 |
| | | | | pentane | <4 | | |
| 19A1 | NR | =>85 | NR | NR | >1.5- | >1-<3 | =<25 |
| | | | | | <4 | | |
| 19A2 | NR | =>85 | NR | n- | >1.5- | >1-<3 | =<25 |
| | | | | pentane | <4 | | |
| 19A3 | NR | =>85 | NR | NR | >2-<4 | >1-<2.5 | =<25 |
| 19A4 | NR | =>85 | NR | n- | >2-<4 | >1-<2.5 | =<25 |
| | | | | pentane | | | |
| 19A5 | NR | =>85 | NR | NR | >2.5 | >1-<2.5 | =<25 |
| | | | | | <4 | | |
| 19A6 | NR | =>85 | NR | n- | >2.5- | >1-<2.5 | =<25 |
| | | | | pentane | <4 | | |
| 19A7 | NR | =>85 | NR | NR | >2.5 | >1.2-<2.0 | =<25 |
| | | | | | <4 | | |
| 19A8 | NR | =>85 | NR | n- | >2.5- | >1.2-<2.05 | =<25 |
| | | | | pentane | <4 | | |
| 19A9 | NR | =>85 | NR | NR | >2.5- | >1-<1.5 | =<25 |
| | | | | | <4 | | |
| 19A10 | NR | =>85 | NR | n- | >2.5- | >1-<1.5 | =<25 |
| | | | | pentane | <4 | | |
| 20A1 | NR | =>95 | NR | NR | >1.5- | >1-<3 | =<25 |
| | | | | | <4 | | |
| 20A2 | NR | =>95 | NR | n- | >1.5- | >1-<3 | =<25 |
| | | | | pentane | <4 | | |
| 20A3 | NR | =>95 | NR | NR | >2-<4 | >1-<2.5 | =<25 |
| 20A4 | NR | =>95 | NR | n- | >2-<4 | >1-<2.5 | =<25 |
| | | | | pentane | | | |
| 20A5 | NR | =>95 | NR | NR | >2.5- | >1-<2.5 | =<25 |
| | | | | | <4 | | |
| 20A6 | NR | =>95 | NR | n- | >2.5- | >1-<2.5 | =<25 |
| | | | | pentane | <4 | | |
| 20A7 | NR | =>95 | NR | NR | >2.5- | >1.2-<2.0 | =<25 |
| | | | | | <4 | | |
| 20A8 | NR | =>95 | NR | n- | >2.5- | >1.2-<2.05 | =<25 |
| | | | | pentane | <4 | | |
| 20A9 | NR | =>95 | NR | NR | >2.5- | >1-<1.5 | =<25 |
| | | | | | <4 | | |
| 20A10 | NR | =>95 | NR | n- | >2.5- | >1-<1.5 | =<25 |
| | | | | pentane | <4 | | |
| 21A1 | NR | =>99 | NR | NR | >1.5- | >1-<3 | =<25 |
| | | | | | <4 | | |
| 21A2 | NR | =>99 | NR | n- | >1.5- | >1-<3 | =<25 |
| | | | | pentane | <4 | | |
| 21A3 | NR | =>99 | NR | NR | >2-<4 | >1-<2.5 | =<25 |
| 21A4 | NR | =>99 | NR | n- | >2-<4 | >1-<2.5 | =<25 |
| | | | | pentane | | | |
| 21A5 | NR | =>99 | NR | NR | >2.5- | >1-<2.5 | =<25 |
| | | | | | <4 | | |
| 21A6 | NR | =>99 | NR | n- | >2.5- | >1-<2.5 | =<25 |
| | | | | pentane | <4 | | |
| 21A7 | NR | =>99 | NR | NR | >2.5- | >1.2-<2.0 | =<25 |
| | | | | | <4 | | |
| 21A8 | NR | =>99 | NR | n- | >2.5- | >1.2-<2.05 | =<25 |
| | | | | pentane | <4 | | |
| 21A9 | NR | =>99 | NR | NR | >2.5- | >1-<1.5 | =<25 |
| | | | | | <4 | | |
| 21A10 | NR | =>99 | NR | n- | >2.5- | >1-<1.5 | =<25 |
| | | | | pentane | <4 | | |
| 22A1 | =>2- | =>50 | NR | NR | >1.5- | >1-<3 | =<25 |
| | =<28 | | | | <4 | | |
| 22A2 | =>2- | =>50 | NR | n- | >1.5- | >1-<3 | =<25 |
| | =<28 | | | pentane | <4 | | |
| 22A3 | =>2- | =>50 | NR | NR | >2-<4 | >1-<2.5 | =<25 |
| | =<28 | | | | | | |
| 22A4 | =>2- | =>50 | NR | n- | >2-<4 | >1-<2.5 | =<25 |
| | =<28 | | | pentane | | | |
| 22A5 | =>2- | =>50 | NR | NR | >2.5- | >1-<2.5 | =<25 |
| | =<28 | | | | <4 | | |
| 22A6 | =>2- | =>50 | NR | n- | >2.5- | >1-<2.5 | =<25 |
| | =<28 | | | pentane | <4 | | |
| 22A7 | =>2- | =>50 | NR | NR | >2.5- | >1.2-<2.0 | =<25 |
| | =<28 | | | | <4 | | |
| 22A8 | =>2- | =>50 | NR | n- | >2.5- | >1.2-<2.05 | =<25 |
| | =<28 | | | pentane | <4 | | |
| 22A9 | =>2- | =>50 | NR | NR | >2.5- | >1-<1.5 | =<25 |
| | =<28 | | | | <4 | | |
| 22A10 | =>2- | =>50 | NR | n- | >2.5- | >1-<1.5 | =<25 |
| | =<28 | | | pentane | <4 | | |
| 23A1 | =>2- | =>75 | NR | NR | >1.5- | >1-<3 | =<25 |
| | =<28 | | | | <4 | | |
| 23A2 | =>2- | =>75 | NR | n- | >1.5- | >1-<3 | =<25 |
| | =<28 | | | pentane | <4 | | |
| 23A3 | =>2- | =>75 | NR | NR | >2-<4 | >1-<2.5 | =<25 |
| | =<28 | | | | | | |
| 23A4 | =>2- | =>75 | NR | n- | >2-<4 | >1-<2.5 | =<25 |
| | =<28 | | | pentane | | | |
| 23A5 | =>2- | =>75 | NR | NR | >2.5- | >1-<2.5 | =<25 |
| | =<28 | | | | <4 | | |
| 23A6 | =>2- | =>75 | NR | n- | >2.5- | >1-<2.5 | =<25 |
| | =<28 | | | pentane | <4 | | |
| 23A7 | =>2- | =>75 | NR | NR | >2.5- | >1.2-<2.0 | =<25 |
| | =<28 | | | | <4 | | |
| 23A8 | =>2- | =>75 | NR | n- | >2.5- | >1.2-<2.05 | =<25 |
| | =<28 | | | pentane | <4 | | |
| 23A9 | =>2- | =>75 | NR | NR | >2.5- | >1-<1.5 | =<25 |
| | =<28 | | | | <4 | | |
| 23A10 | =>2- | =>75 | NR | n- | >2.5- | >1-<1.5 | =<25 |
| | =<28 | | | pentane | <4 | | |
| 24A1 | =>2- | =>85 | NR | NR | >1.5- | >1-<3 | =<25 |
| | =<28 | | | | <4 | | |
| 24A2 | =>2- | =>85 | NR | n- | >1.5- | >1-<3 | =<25 |
| | =<28 | | | pentane | <4 | | |
| 24A3 | =>2- | =>85 | NR | NR | >2-<4 | >1-<2.5 | =<25 |
| | =<28 | | | | | | |
| 24A4 | =>2- | =>85 | NR | n- | >2-<4 | >1-<2.5 | =<25 |
| | =<28 | | | pentane | | | |
| 24A5 | =>2- | =>85 | NR | NR | >2.5- | >1-<2.5 | =<25 |
| | =<28 | | | | <4 | | |
| 24A6 | =>2- | =>85 | NR | n- | >2.5- | >1-<2.5 | =<25 |
| | =<28 | | | pentane | <4 | | |
| 24A7 | =>2- | =>85 | NR | NR | >2.5- | >1.2-<2.0 | =<25 |
| | =<28 | | | | <4 | | |
| 24A8 | =>2- | =>85 | NR | n- | >2.5 | >1.2-<2.05 | =<25 |
| | =<28 | | | pentane | <4 | | |
| 24A9 | =>2- | =>85 | NR | NR | >2.5- | >1-<1.5 | =<25 |
| | =<28 | | | | <4 | | |
| 24A10 | =>2- | =>85 | NR | n- | >2.5- | >1-<1.5 | =<25 |
| | =<28 | | | pentane | <4 | | |
| 25A1 | =>2- | =>95 | NR | NR | >1.5- | >1-<3 | =<25 |
| | =<28 | | | | <4 | | |
| 25A2 | =>2- | =>95 | NR | n- | >1.5- | >1-<3 | =<25 |
| | =<28 | | | pentane | <4 | | |
| 25A3 | =>2- | =>95 | NR | NR | >2-<4 | >1-<2.5 | =<25 |
| | =<28 | | | | | | |
| 25A4 | =>2- | =>95 | NR | n- | >2-<4 | >1-<2.5 | =<25 |
| | =<28 | | | pentane | | | |
| 25A5 | =>2- | =>95 | NR | NR | >2.5- | >1-<2.5 | =<25 |
| | =<28 | | | | <4 | | |
| 25A6 | =>2- | =>95 | NR | n- | >2.5- | >1-<2.5 | =<25 |
| | =<28 | | | pentane | <4 | | |
| 25A7 | =>2- | =>95 | NR | NR | >2.5- | >1.2-<2.0 | =<25 |
| | =<28 | | | | <4 | | |
| 25A8 | =>2- | =>95 | NR | n- | >2.5- | >1.2-<2.05 | =<25 |
| | =<28 | | | pentane | <4 | | |
| 25A9 | =>2- | =>95 | NR | NR | >2.5- | >1-<1.5 | =<25 |
| | =<28 | | | | <4 | | |
| 25A10 | =>2- | =>95 | NR | n- | >2.5- | >1-<1.5 | =<25 |
| | =<28 | | | pentane | <4 | | |
| 26A1 | =>2- | =>99 | NR | NR | >1.5- | >1-<3 | =<25 |
| | =<28 | | | | <4 | | |
| 26A2 | =>2- | =>99 | NR | n- | >1.5- | >1-<3 | =<25 |
| | =<28 | | | pentane | <4 | | |
| 26A3 | =>2- | =>99 | NR | NR | >2-<4 | >1-<2.5 | =<25 |
| | =<28 | | | | | | |
| 26A4 | =>2- | =>99 | NR | n- | >2-<4 | >1-<2.5 | =<25 |
| | =<28 | | | pentane | | | |
| 26A5 | =>2- | =>99 | NR | NR | >2.5- | >1-<2.5 | =<25 |
| | =<28 | | | | <4 | | |
| 26A6 | =>2- | =>99 | NR | n- | >2.5- | >1-<2.5 | =<25 |
| | =<28 | | | pentane | <4 | | |
| 26A7 | =>2- | =>99 | NR | NR | >2.5- | >1.2-<2.0 | =<25 |
| | =<28 | | | | <4 | | |
| 26A8 | =>2- | =>99 | NR | n- | >2.5- | >1.2-<2.05 | =<25 |
| | =<28 | | | pentane | <4 | | |
| 26A9 | =>2- | =>99 | NR | NR | >2.5- | >1-<1.5 | =<25 |
| | =<28 | | | | <4 | | |
| 26A10 | =>2- | =>99 | NR | n- | >2.5- | >1-<1.5 | =<25 |
| | =<28 | | | pentane | <4 | | |
| 27A1 | =>2- | =>50 | NR | NR | >1.5- | >1-<3 | =<25 |
| | =<10 | | | | <4 | | |
| 272 | =>2- | =>50 | NR | n- | >1.5- | >1-<3 | =<25 |
| | =<10 | | | pentane | <4 | | |
| 27A3 | =>2- | =>50 | NR | NR | >2-<4 | >1-<2.5 | =<25 |
| | =<10 | | | | | | |
| 27A4 | =>2- | =>50 | NR | n- | >2-<4 | >1-<2.5 | =<25 |
| | =<10 | | | pentane | | | |
| 27A5 | =>2- | =>50 | NR | NR | >2.5- | >1-<2.5 | =<25 |
| | =<10 | | | | <4 | | |
| 27A6 | =>2- | =>50 | NR | n- | >2.5- | >1-<2.5 | =<25 |
| | =<10 | | | pentane | <4 | | |
| 27A7 | =>2- | =>50 | NR | NR | >2.5- | >1.2-<2.0 | =<25 |
| | =<10 | | | | <4 | | |
| 27A8 | =>2- | =>50 | NR | n- | >2.5- | >1.2-<2.05 | =<25 |
| | =<10 | | | pentane | <4 | | |
| 27A9 | =>2- | =>50 | NR | NR | >2.5- | >1-<1.5 | =<25 |
| | =<10 | | | | <4 | | |
| 27A10 | =>2- | =>50 | NR | n- | >2.5- | >1-<1.5 | =<25 |
| | =<10 | | | pentane | <4 | | |
| 28A1 | =>2- | =>75 | NR | NR | >1.5- | >1-<3 | =<25 |
| | =<10 | | | | <4 | | |
| 28A2 | =>2- | =>75 | NR | n- | >1.5- | >1-<3 | =<25 |
| | =<10 | | | pentane | <4 | | |
| 28A3 | =>2- | =>75 | NR | NR | >2-<4 | >1-<2.5 | =<25 |
| | =<10 | | | | | | |
| 28A4 | =>2- | =>75 | NR | n- | >2-<4 | >1-<2.5 | =<25 |
| | =<10 | | | pentane | | | |
| 28A5 | =>2- | =>75 | NR | NR | >2.5- | >1-<2.5 | =<25 |
| | =<10 | | | | <4 | | |
| 28A6 | =>2- | =>75 | NR | n- | >2.5- | >1-<2.5 | =<25 |
| | =<10 | | | pentane | <4 | | |
| 28A7 | =>2- | =>75 | NR | NR | >2.5- | >1.2-<2.0 | =<25 |
| | =<10 | | | | <4 | | |
| 28A8 | =>2- | =>75 | NR | n- | >2.5- | >1.2-<2.05 | =<25 |
| | =<10 | | | pentane | <4 | | |
| 28A9 | =>2- | =>75 | NR | NR | >2.5- | >1-<1.5 | =<25 |
| | =<10 | | | | <4 | | |
| 28A10 | =>2- | =>75 | NR | n- | >2.5- | >1-<1.5 | =<25 |
| | =<10 | | | pentane | <4 | | |
| 29A1 | =>2- | =>85 | NR | NR | >1.5- | >1-<3 | =<25 |
| | =<10 | | | | <4 | | |
| 29A2 | =>2- | =>85 | NR | n- | >1.5- | >1-<3 | =<25 |
| | =<10 | | | pentane | <4 | | |
| 29A3 | =>2- | =>85 | NR | NR | >2-<4 | >1-<2.5 | =<25 |
| | =<10 | | | | | | |
| 29A4 | =>2- | =>85 | NR | n- | >2-<4 | >1-<2.5 | =<25 |
| | =<10 | | | pentane | | | |
| 29A5 | =>2- | =>85 | NR | NR | >2.5- | >1-<2.5 | =<25 |
| | =<10 | | | | <4 | | |
| 29A6 | =>2- | =>85 | NR | n- | >2.5- | >1-<2.5 | =<25 |
| | =<10 | | | pentane | <4 | | |
| 29A7 | =>2- | =>85 | NR | NR | >2.5- | >1.2-<2.0 | =<25 |
| | =<10 | | | | <4 | | |
| 29A8 | =>2- | =>85 | NR | n- | >2.5 | >1.2-<2.05 | =<25 |
| | =<10 | | | pentane | <4 | | |
| 29A9 | =>2- | =>85 | NR | NR | >2.5- | >1-<1.5 | =<25 |
| | =<10 | | | | <4 | | |
| 29A10 | =>2- | =>85 | NR | n- | >2.5- | >1-<1.5 | =<25 |
| | =<10 | | | pentane | <4 | | |
| 30A1 | =>2- | =>95 | NR | NR | >1.5- | >1-<3 | =<25 |
| | =<10 | | | | <4 | | |
| 30A2 | =>2- | =>95 | NR | n- | >1.5- | >1-<3 | =<25 |
| | =<10 | | | pentane | <4 | | |
| 30A3 | =>2- | =>95 | NR | NR | >2-<4 | >1-<2.5 | =<25 |
| | =<10 | | | | | | |
| 30A4 | =>2- | =>95 | NR | n- | >2-<4 | >1-<2.5 | =<25 |
| | =<10 | | | pentane | | | |
| 30A5 | =>2- | =>95 | NR | NR | >2.5- | >1-<2.5 | =<25 |
| | =<10 | | | | <4 | | |
| 30A6 | =>2- | =>95 | NR | n- | >2.5- | >1-<2.5 | =<25 |
| | =<10 | | | pentane | <4 | | |
| 30A7 | =>2- | =>95 | NR | NR | >2.5- | >1.2-<2.0 | =<25 |
| | =<10 | | | | <4 | | |
| 30A8 | =>2- | =>95 | NR | n- | >2.5- | >1.2-<2.05 | =<25 |
| | =<10 | | | pentane | <4 | | |
| 30A9 | =>2- | =>95 | NR | NR | >2.5- | >1-<1.5 | =<25 |
| | =<10 | | | | <4 | | |
| 30A10 | =>2- | =>95 | NR | n- | >2.5- | >1-<1.5 | =<25 |
| | =<10 | | | pentane | <4 | | |
| 31A1 | =>2- | =>99 | NR | NR | >1.5- | >1-<3 | =<25 |
| | =<10 | | | | <4 | | |
| 31A2 | =>2. | =>99 | NR | n- | >1.5- | >1-<3 | =<25 |
| | =<10 | | | pentane | <4 | | |
| 31A3 | =>2- | =>99 | NR | NR | >2-<4 | >1-<2.5 | =<25 |
| | =<10 | | | | | | |
| 31A4 | =>2- | =>99 | NR | n- | >2-<4 | >1-<2.5 | =<25 |
| | =<10 | | | pentane | | | |
| 31A5 | =>2- | =>99 | NR | NR | >2.5- | >1-<2.5 | =<25 |
| | =<10 | | | | <4 | | |
| 31A6 | =>2- | =>99 | NR | n- | >2.5- | >1-<2.5 | =<25 |
| | =<10 | | | pentane | <4 | | |
| 31A7 | =>2- | =>99 | NR | NR | >2.5- | >1.2-<2.0 | =<25 |
| | =<10 | | | | <4 | | |
| 31A8 | =>2- | =>99 | NR | n- | >2.5- | >1.2-<2.05 | =<25 |
| 31A9 | =>2- | =>99 | NR | NR | >2.5- | >1-<1.5 | =<25 |
| | =<10 | | | | <4 | | |
| 31A10 | =>2- | =>99 | NR | n- | >2.5- | >1-<1.5 | =<25 |
| | =<10 | | | pentane | <4 | | |

In general it is contemplated that the average size and shape of the expanded pellets of the present invention, including each of Expanded Pellets 1-31, may vary widely in accordance with shapes and sizes known to those skilled in the art, and all such shapes and sizes are within the scope of the present invention. Embodiments of the expanded pellets, including each of Expanded Pellets 1-31, include pellets which are generally spherical and/or disc-shaped and/or cylindrical and/or bead shaped. Embodiments of the expanded pellets, including each of Expanded Pellets 1-31, include pellets which have an average particle size in the range of from about 0.6 mm to about 30 mm, or from 0.6 mm to about 15 mm, or from 0.6 mm to about 9 mm. Embodiments of the expanded pellets, including each of Expanded Pellets 1-31, include pellets which are generally spherical and/or disc-shaped and/or cylindrical and have an average particle size in the range of from about 0.6 mm to about 30 mm, or from 0.6 mm to about 15 mm, or from 0.6 mm to about 9 mm.

### Foam

The present invention includes open cell foams, including Foams 1A-1D. In preferred embodiments the foams of the present invention are further limited as indicated in the Foam Table below, with each foam being named in the first column by a Foam No., and reference herein to a Foam by that number is understood to incorporate all of the limitations described in the row corresponding to the Foam number.

FOAM TABLE

| | | | | | | | Foam | |
|---|---|---|---|---|---|---|---|---|
| | | | | | | | Property | |
| | | | | | | | | Ther- |
| | | | | | | | | mal |
| | Thermoplastic | | | Blowing Agent | | | | Con- |
| | MFI, | | | | | HFCO- | Den- | duc- |
| | gm/ | wt. | | Pentane | | 1233zd(E) | sity | tivity |
| Foam | 10 | % | | | Wt. | Wt. | kg/ | mW/ |
| No. | min | PS | Other | Isomer | % | % | m³ | mK |
| 2A1 | NR | =>50 | NR | NR | >1- | >0.5-<2 | =<30 | =<35 |
| | | | | | <4 | | | |
| 2A2 | NR | =>50 | NR | n- | >1- | >0.5-<2 | =<30 | =<35 |
| | | | | pentane | <4 | | | |
| 2A3 | NR | =>50 | NR | NR | >1.5- | >0.5-<2 | =<30 | =<35 |
| | | | | | <4 | | | |
| 2A4 | NR | =>50 | NR | n- | >1.5- | >0.5-<2 | =<30 | =<35 |
| | | | | pentane | <4 | | | |
| 2A5 | NR | =>50 | NR | NR | >1.5- | >0.5-<1.5 | =<30 | =<35 |
| | | | | | <4 | | | |
| 2A6 | NR | =>50 | NR | n- | >1.5- | >0.5-<1.5 | =<30 | =<35 |
| | | | | pentane | <4 | | | |
| 2A7 | NR | =>50 | NR | NR | >1.5- | >0.5-<2 | =<30 | =<35 |
| | | | | | <3 | | | |
| 2A8 | NR | =>50 | NR | n- | >1.5- | >0.5-<2 | =<30 | =<35 |
| | | | | pentane | <3 | | | |
| 2A9 | NR | =>50 | NR | NR | >1.5- | >1-<1.5 | =<30 | =<35 |
| | | | | | <3 | | | |
| 2A10 | NR | =>50 | NR | n- | >1.5- | >1-<1.5 | =<30 | =<35 |
| | | | | pentane | <3 | | | |
| 3A1 | NR | =>75 | NR | NR | >1- | >0.5-<2 | =<30 | =<35 |
| | | | | | <4 | | | |
| 3A2 | NR | =>75 | NR | n- | >1- | >0.5-<2 | =<30 | =<35 |
| | | | | pentane | <4 | | | |
| 3A3 | NR | =>75 | NR | NR | >1.5- | >0.5-<2 | =<30 | =<35 |
| | | | | | <4 | | | |
| 3A4 | NR | =>75 | NR | n- | >1.5- | >0.5-<2 | =<30 | =<35 |
| | | | | pentane | <4 | | | |
| 3A5 | NR | =>75 | NR | NR | >1.5- | >0.5-<1.5 | =<30 | =<35 |
| | | | | | <4 | | | |
| 3A6 | NR | =>75 | NR | n- | >1.5- | >0.5-<1.5 | =<30 | =<35 |
| | | | | pentane | <4 | | | |
| 3A7 | NR | =>75 | NR | NR | >1.5- | >0.5-<2 | =<30 | =<35 |
| | | | | | <3 | | | |
| 3A8 | NR | =>75 | NR | n- | >1.5- | >0.5-<2 | =<30 | =<35 |
| | | | | pentane | <3 | | | |
| 3A9 | NR | =>75 | NR | NR | >1.5- | >1-<1.5 | =<30 | =<35 |
| | | | | | <3 | | | |
| 3A10 | NR | =>75 | NR | n- | >1.5- | >1-<1.5 | =<30 | =<35 |
| | | | | pentane | <3 | | | |
| 4A1 | NR | =>85 | NR | NR | >1- | >0.5-<2 | =<30 | =<35 |
| | | | | | <4 | | | |
| 4A2 | NR | =>85 | NR | n- | >1- | >0.5-<2 | =<30 | =<35 |
| | | | | pentane | <4 | | | |
| 4A3 | NR | =>85 | NR | NR | >1.5- | >0.5-<2 | =<30 | =<35 |
| | | | | | <4 | | | |
| 4A4 | NR | =>85 | NR | n- | >1.5- | >0.5-<2 | =<30 | =<35 |
| | | | | pentane | <4 | | | |
| 4A5 | NR | =>85 | NR | NR | >1.5- | >0.5-<1.5 | =<30 | =<35 |
| | | | | | <4 | | | |
| 4A6 | NR | =>85 | NR | n- | >1.5- | >0.5-<1.5 | =<30 | =<35 |
| | | | | pentane | <4 | | | |
| 4A7 | NR | =>85 | NR | NR | >1.5- | >0.5-<2 | =<30 | =<35 |
| | | | | | <3 | | | |
| 4A8 | NR | =>85 | NR | n- | >1.5- | >0.5-<2 | =<30 | =<35 |
| | | | | pentane | <3 | | | |
| 4A9 | NR | =>85 | NR | NR | >1.5- | >1-<1.5 | =<30 | =<35 |
| | | | | | <3 | | | |
| 4A10 | NR | =>85 | NR | n- | >1.5- | >1-<1.5 | =<30 | =<35 |
| | | | | pentane | <3 | | | |
| 5A1 | NR | =>95 | NR | NR | >1- | >0.5-<2 | =<30 | =<35 |
| | | | | | <4 | | | |
| 5A2 | NR | =>95 | NR | n- | >1- | >0.5-<2 | =<30 | =<35 |
| | | | | pentane | <4 | | | |
| 5A3 | NR | =>95 | NR | NR | >1.5- | >0.5-<2 | =<30 | =<35 |
| | | | | | <4 | | | |
| 5A4 | NR | =>95 | NR | n- | >1.5- | >0.5-<2 | =<30 | =<35 |
| | | | | pentane | <4 | | | |
| 5A5 | NR | =>95 | NR | NR | >1.5- | >0.5-<1.5 | =<30 | =<35 |
| | | | | | <4 | | | |
| 5A6 | NR | =>95 | NR | n- | >1.5- | >0.5-<1.5 | =<30 | =<35 |
| | | | | pentane | <4 | | | |
| 5A7 | NR | =>95 | NR | NR | >1.5- | >0.5-<2 | =<30 | =<35 |
| | | | | | <3 | | | |
| 5A8 | NR | =>95 | NR | n- | >1.5- | >0.5-<2 | =<30 | =<35 |
| | | | | pentane | <3 | | | |
| 5A9 | NR | =>95 | NR | NR | >1.5- | >1-<1.5 | =<30 | =<35 |
| | | | | | <3 | | | |
| 5A10 | NR | =>95 | NR | n- | >1.5- | >1-<1.5 | =<30 | =<35 |
| | | | | pentane | <3 | | | |
| 6A1 | NR | =>99 | NR | NR | >1- | >0.5-<2 | =<30 | =<35 |
| | | | | | <4 | | | |
| 6A2 | NR | =>99 | NR | n- | >1- | >0.5-<2 | =<30 | =<35 |
| | | | | pentane | <4 | | | |
| 6A3 | NR | =>99 | NR | NR | >1.5- | >0.5-<2 | =<30 | =<35 |
| | | | | | <4 | | | |
| 6A4 | NR | =>99 | NR | n- | >1.5- | >0.5-<2 | =<30 | =<35 |
| | | | | pentane | <4 | | | |
| 6A5 | NR | =>99 | NR | NR | >1.5- | >0.5-<1.5 | =<30 | =<35 |
| | | | | | <4 | | | |
| 6A6 | NR | =>99 | NR | n- | >1.5- | >0.5-<1.5 | =<30 | =<35 |
| | | | | pentane | <4 | | | |
| 6A7 | NR | =>99 | NR | NR | >1.5- | >0.5-<2 | =<30 | =<35 |
| | | | | | <3 | | | |
| 6A8 | NR | =>99 | NR | n- | >1.5- | >0.5-<2 | =<30 | =<35 |
| | | | | pentane | <3 | | | |
| 6A9 | NR | =>99 | NR | NR | >1.5- | >1-<1.5 | =<30 | =<35 |
| | | | | | <3 | | | |
| 6A10 | NR | =>99 | NR | n- | >1.5- | >1-<1.5 | =<30 | =<35 |
| | | | | pentane | <3 | | | |
| 7A1 | =>2- | =>50 | NR | NR | >1- | >0.5-<2 | =<30 | =<35 |
| | =<28 | | | | <4 | | | |
| 7A2 | =>2- | =>50 | NR | n- | >1- | >0.5-<2 | =<30 | =<35 |
| | =<28 | | | pentane | <4 | | | |
| 7A3 | =>2- | =>50 | NR | NR | >1.5- | >0.5-<2 | =<30 | =<35 |
| | =<28 | | | | <4 | | | |
| 7A4 | =>2- | =>50 | NR | n- | >1.5- | >0.5-<2 | =<30 | =<35 |
| | =<28 | | | pentane | <4 | | | |
| 7A5 | =>2- | =>50 | NR | NR | >1.5- | >0.5-<1.5 | =<30 | =<35 |
| | =<28 | | | | <4 | | | |
| 7A6 | =>2- | =>50 | NR | n- | >1.5- | >0.5-<1.5 | =<30 | =<35 |
| | =<28 | | | pentane | <4 | | | |
| 7A7 | =>2- | =>50 | NR | NR | >1.5- | >0.5-<2 | =<30 | =<35 |
| | =<28 | | | | <3 | | | |
| 7A8 | =>2- | =>50 | NR | n- | >1.5- | >0.5-<2 | =<30 | =<35 |
| | =<28 | | | pentane | <3 | | | |
| 7A9 | =>2- | =>50 | NR | NR | >1.5- | >1-<1.5 | =<30 | =<35 |
| | =<28 | | | | <3 | | | |
| 7A10 | =>2- | =>50 | NR | n- | >1.5- | >1-<1.5 | =<30 | =<35 |
| | =<28 | | | pentane | <3 | | | |
| 8A1 | =>2- | =>75 | NR | NR | >1- | >0.5-<2 | =<30 | =<35 |
| | =<28 | | | | <4 | | | |
| 8A2 | =>2- | =>75 | NR | n- | >1- | >0.5-<2 | =<30 | =<35 |
| | =<28 | | | pentane | <4 | | | |
| 8A3 | =>2- | =>75 | NR | NR | >1.5- | >0.5-<2 | =<30 | =<35 |
| | =<28 | | | | <4 | | | |
| 8A4 | =>2- | =>75 | NR | n- | >1.5- | >0.5-<2 | =<30 | =<35 |
| | =<28 | | | pentane | <4 | | | |
| 8A5 | =>2- | =>75 | NR | NR | >1.5- | >0.5-<1.5 | =<30 | =<35 |
| | =<28 | | | | <4 | | | |
| 8A6 | =>2- | =>75 | NR | n- | >1.5- | >0.5-<1.5 | =<30 | =<35 |
| | =<28 | | | pentane | <4 | | | |
| 8A7 | =>2- | =>75 | NR | NR | >1.5- | >0.5-<2 | =<30 | =<35 |
| | =<28 | | | | <3 | | | |
| 8A8 | =>2- | =>75 | NR | n- | >1.5- | >0.5-<2 | =<30 | =<35 |
| | =<28 | | | pentane | <3 | | | |
| 8A9 | =>2- | =>75 | NR | NR | >1.5- | >1-<1.5 | =<30 | =<35 |
| | =<28 | | | | <3 | | | |
| 8A10 | =>2- | =>75 | NR | n- | >1.5- | >1-<1.5 | =<30 | =<35 |
| | =<28 | | | pentane | <3 | | | |
| 9A1 | =>2- | =>85 | NR | NR | >1- | >0.5-<2 | =<30 | =<35 |
| | =<28 | | | | <4 | | | |
| 9A2 | =>2- | =>85 | NR | n- | >1- | >0.5-<2 | =<30 | =<35 |
| | =<28 | | | pentane | <4 | | | |
| 9A3 | =>2- | =>85 | NR | NR | >1.5- | >0.5-<2 | =<30 | =<35 |
| | =<28 | | | | <4 | | | |
| 9A4 | =>2- | =>85 | NR | n- | >1.5- | >0.5-<2 | =<30 | =<35 |
| | =<28 | | | pentane | <4 | | | |
| 9A5 | =>2- | =>85 | NR | NR | >1.5- | >0.5-<1.5 | =<30 | =<35 |
| | =<28 | | | | <4 | | | |
| 9A6 | =>2- | =>85 | NR | n- | >1.5- | >0.5-<1.5 | =<30 | =<35 |
| | =<28 | | | pentane | <4 | | | |
| 9A7 | =>2- | =>85 | NR | NR | >1.5- | >0.5-<2 | =<30 | =<35 |
| | =<28 | | | | <3 | | | |
| 9A8 | =>2- | =>85 | NR | n- | >1.5- | >0.5-<2 | =<30 | =<35 |
| | =<28 | | | pentane | <3 | | | |
| 9A9 | =>2- | =>85 | NR | NR | >1.5- | >1-<1.5 | =<30 | =<35 |
| | =<28 | | | | <3 | | | |
| 9A10 | =>2- | =>85 | NR | n- | >1.5- | >1-<1.5 | =<30 | =<35 |
| | =<28 | | | pentane | <3 | | | |
| 10A1 | =>2- | =>95 | NR | NR | >1- | >0.5-<2 | =<30 | =<35 |
| | =<28 | | | | <4 | | | |
| 10A2 | =>2- | =>95 | NR | n- | >1- | >0.5-<2 | =<30 | =<35 |
| | =<28 | | | pentane | <4 | | | |
| 10A3 | =>2- | =>95 | NR | NR | >1.5- | >0.5-<2 | =<30 | =<35 |
| | =<28 | | | | <4 | | | |
| 10A4 | =>2- | =>95 | NR | n- | >1.5- | >0.5-<2 | =<30 | =<35 |
| | =<28 | | | pentane | <4 | | | |
| 10A5 | =>2- | =>95 | NR | NR | >1.5- | >0.5-<1.5 | =<30 | =<35 |
| | =<28 | | | | <4 | | | |
| 10A6 | =>2- | =>95 | NR | n- | >1.5- | >0.5-<1.5 | =<30 | =<35 |
| | =<28 | | | pentane | <4 | | | |
| 10A7 | =>2- | =>95 | NR | NR | >1.5- | >0.5-<2 | =<30 | =<35 |
| | =<28 | | | | <3 | | | |
| 10A8 | =>2- | =>95 | NR | n- | >1.5- | >0.5-<2 | =<30 | =<35 |
| | =<28 | | | pentane | <3 | | | |
| 10A9 | =>2- | =>95 | NR | NR | >1.5- | >1-<1.5 | =<30 | =<35 |
| | =<28 | | | | <3 | | | |
| 10A10 | =>2- | =>95 | NR | n- | >1.5- | >1-<1.5 | =<30 | =<35 |
| | =<28 | | | pentane | <3 | | | |
| 11A1 | =>2- | =>99 | NR | NR | >1- | >0.5-<2 | =<30 | =<35 |
| | =<28 | | | | <4 | | | |
| 11A2 | =>2- | =>99 | NR | n- | >1- | >0.5-<2 | =<30 | =<35 |
| | =<28 | | | pentane | <4 | | | |
| 11A3 | =>2- | =>99 | NR | NR | >1.5- | >0.5-<2 | =<30 | =<35 |
| | =<28 | | | | <4 | | | |
| 11A4 | =>2- | =>99 | NR | n- | >1.5- | >0.5-<2 | =<30 | =<35 |
| | =<28 | | | pentane | <4 | | | |
| 11A5 | =>2- | =>99 | NR | NR | >1.5- | >0.5-<1.5 | =<30 | =<35 |
| | =<28 | | | | <4 | | | |
| 11A6 | =>2- | =>99 | NR | n- | >1.5- | >0.5-<1.5 | =<30 | =<35 |
| | =<28 | | | pentane | <4 | | | |
| 11A7 | =>2- | =>99 | NR | NR | >1.5- | >0.5-<2 | =<30 | =<35 |
| | =<28 | | | | <3 | | | |
| 11A8 | =>2- | =>99 | NR | n- | >1.5- | >0.5-<2 | =<30 | =<35 |
| | =<28 | | | pentane | <3 | | | |
| 11A9 | =>2- | =>99 | NR | NR | >1.5- | >1-<1.5 | =<30 | =<35 |
| | =<28 | | | | <3 | | | |
| 11A10 | =>2- | =>99 | NR | n- | >1.5- | >1-<1.5 | =<30 | =<35 |
| | =<28 | | | pentane | <3 | | | |
| 12A1 | =>2- | =>50 | NR | NR | >1- | >0.5-<2 | =<30 | =<35 |
| | =<10 | | | | <4 | | | |
| 12A2 | =>2- | =>50 | NR | n- | >1- | >0.5-<2 | =<30 | =<35 |
| | =<10 | | | pentane | <4 | | | |
| 12A3 | =>2- | =>50 | NR | NR | >1.5- | >0.5-<2 | =<30 | =<35 |
| | =<10 | | | | <4 | | | |
| 12A4 | =>2- | =>50 | NR | n- | >1.5- | >0.5-<2 | =<30 | =<35 |
| | =<10 | | | pentane | <4 | | | |
| 12A5 | =>2- | =>50 | NR | NR | >1.5- | >0.5-<1.5 | =<30 | =<35 |
| | =<10 | | | | <4 | | | |
| 12A6 | =>2- | =>50 | NR | n- | >1.5- | >0.5-<1.5 | =<30 | =<35 |
| | =<10 | | | pentane | <4 | | | |
| 12A7 | =>2- | =>50 | NR | NR | >1.5- | >0.5-<2 | =<30 | =<35 |
| | =<10 | | | | <3 | | | |
| 12A8 | =>2- | =>50 | NR | n- | >1.5- | >0.5-<2 | =<30 | =<35 |
| | =<10 | | | pentane | <3 | | | |
| 12A9 | =>2- | =>50 | NR | NR | >1.5- | >1-<1.5 | =<30 | =<35 |
| | =<10 | | | | <3 | | | |
| 12A10 | =>2- | =>50 | NR | n- | >1.5- | >1-<1.5 | =<30 | =<35 |
| | =<10 | | | pentane | <3 | | | |
| 13A1 | =>2- | =>75 | NR | NR | >1- | >0.5-<2 | =<30 | =<35 |
| | =<10 | | | | <4 | | | |
| 13A2 | =>2- | =>75 | NR | n- | >1- | >0.5-<2 | =<30 | =<35 |
| | =<10 | | | pentane | <4 | | | |
| 13A3 | =>2- | =>75 | NR | NR | >1.5- | >0.5-<2 | =<30 | =<35 |
| | =<10 | | | | <4 | | | |
| 13A4 | =>2- | =>75 | NR | n- | >1.5- | >0.5-<2 | =<30 | =<35 |
| | =<10 | | | pentane | <4 | | | |
| 13A5 | =>2- | =>75 | NR | NR | >1.5- | >0.5-<1.5 | =<30 | =<35 |
| | =<10 | | | | <4 | | | |
| 13A6 | =>2- | =>75 | NR | n- | >1.5- | >0.5-<1.5 | =<30 | =<35 |
| | =<10 | | | pentane | <4 | | | |
| 13A7 | =>2- | =>75 | NR | NR | >1.5- | >0.5-<2 | =<30 | =<35 |
| | =<10 | | | | <3 | | | |
| 13A8 | =>2- | =>75 | NR | n- | >1.5- | >0.5-<2 | =<30 | =<35 |
| | =<10 | | | pentane | <3 | | | |
| 13A9 | =>2- | =>75 | NR | NR | >1.5- | >1-<1.5 | =<30 | =<35 |
| | =<10 | | | | <3 | | | |
| 13A10 | =>2- | =>75 | NR | n- | >1.5- | >1-<1.5 | =<30 | =<35 |
| | =<10 | | | pentane | <3 | | | |
| 14A1 | =>2- | =>85 | NR | NR | >1- | >0.5-<2 | =<30 | =<35 |
| | =<10 | | | | <4 | | | |
| 14A2 | =>2- | =>85 | NR | n- | >1- | >0.5-<2 | =<30 | =<35 |
| | =<10 | | | pentane | <4 | | | |
| 14A3 | =>2- | =>85 | NR | NR | >1.5- | >0.5-<2 | =<30 | =<35 |
| | =<10 | | | | <4 | | | |
| 14A4 | =>2- | =>85 | NR | n- | >1.5- | >0.5-<2 | =<30 | =<35 |
| | =<10 | | | pentane | <4 | | | |
| 14A5 | =>2- | =>85 | NR | NR | >1.5- | >0.5-<1.5 | =<30 | =<35 |
| | =<10 | | | | <4 | | | |
| 14A6 | =>2- | =>85 | NR | n- | >1.5- | >0.5-<1.5 | =<30 | =<35 |
| | =<10 | | | pentane | <4 | | | |
| 14A7 | =>2- | =>85 | NR | NR | >1.5- | >0.5-<2 | =<30 | =<35 |
| | =<10 | | | | <3 | | | |
| 14A8 | =>2- | =>85 | NR | n- | >1.5- | >0.5-<2 | =<30 | =<35 |
| | =<10 | | | pentane | <3 | | | |
| 14A9 | =>2- | =>85 | NR | NR | >1.5- | >1-<1.5 | =<30 | =<35 |
| | =<10 | | | | <3 | | | |
| 14A10 | =>2- | =>85 | NR | n- | >1.5- | >1-<1.5 | =<30 | =<35 |
| | =<10 | | | pentane | <3 | | | |
| 15A1 | =>2- | =>95 | NR | NR | >1- | >0.5-<2 | =<30 | =<35 |
| | =<10 | | | | <4 | | | |
| 15A2 | =>2- | =>95 | NR | n- | >1- | >0.5-<2 | =<30 | =<35 |
| | =<10 | | | pentane | <4 | | | |
| 15A3 | =>2- | =>95 | NR | NR | >1.5- | >0.5-<2 | =<30 | =<35 |
| | =<10 | | | | <4 | | | |
| 15A4 | =>2- | =>95 | NR | n- | >1.5- | >0.5-<2 | =<30 | =<35 |
| | =<10 | | | pentane | <4 | | | |
| 15A5 | =>2- | =>95 | NR | NR | >1.5- | >0.5-<1.5 | =<30 | =<35 |
| | =<10 | | | | <4 | | | |
| 15A6 | =>2- | =>95 | NR | n- | >1.5- | >0.5-<1.5 | =<30 | =<35 |
| | =<10 | | | pentane | <4 | | | |
| 15A7 | =>2- | =>95 | NR | NR | >1.5- | >0.5-<2 | =<30 | =<35 |
| | =<10 | | | | <3 | | | |
| 15A8 | =>2- | =>95 | NR | n- | >1.5- | >0.5-<2 | =<30 | =<35 |
| | =<10 | | | pentane | <3 | | | |
| 15A9 | =>2- | =>95 | NR | NR | >1.5- | >1-<1.5 | =<30 | =<35 |
| | =<10 | | | | <3 | | | |
| 15A10 | =>2- | =>95 | NR | n- | >1.5- | >1-<1.5 | =<30 | =<35 |
| | =<10 | | | pentane | <3 | | | |
| 16A1 | =>2- | =>99 | NR | NR | >1- | >0.5-<2 | =<30 | =<35 |
| | =<10 | | | | <4 | | | |
| 16A2 | =>2- | =>99 | NR | n- | >1- | >0.5-<2 | =<30 | =<35 |
| | =<10 | | | pentane | <4 | | | |
| 16A3 | =>2- | =>99 | NR | NR | >1.5- | >0.5-<2 | =<30 | =<35 |
| | =<10 | | | | <4 | | | |
| 16A4 | =>2- | =>99 | NR | n- | >1.5- | >0.5-<2 | =<30 | =<35 |
| | =<10 | | | pentane | <4 | | | |
| 16A5 | =>2- | =>99 | NR | NR | >1.5- | >0.5-<1.5 | =<30 | =<35 |
| | =<10 | | | | <4 | | | |
| 16A6 | =>2- | =>99 | NR | n- | >1.5- | >0.5-<1.5 | =<30 | =<35 |
| | =<10 | | | pentane | <4 | | | |
| 16A7 | =>2- | =>99 | NR | NR | >1.5- | >0.5-<2 | =<30 | =<35 |
| | =<10 | | | | <3 | | | |
| 16A8 | =>2- | =>99 | NR | n- | >1.5- | >0.5-<2 | =<30 | =<35 |
| | =<10 | | | pentane | <3 | | | |
| 16A9 | =>2- | =>99 | NR | NR | >1.5- | >1-<1.5 | =<30 | =<35 |
| | =<10 | | | | <3 | | | |
| 16A10 | =>2- | =>99 | NR | n- | >1.5- | >1-<1.5 | =<30 | =<35 |
| | =<10 | | | pentane | <3 | | | |
| 17A1 | NR | =>50 | NR | NR | >1- | >0.5-<2 | =<25 | NR |
| | | | | | <4 | | | |
| 17A2 | NR | =>50 | NR | n- | >1- | >0.5-<2 | =<25 | NR |
| | | | | pentane | <4 | | | |
| 17A3 | NR | =>50 | NR | NR | >1.5- | >0.5-<2 | =<25 | NR |
| | | | | | <4 | | | |
| 17A4 | NR | =>50 | NR | n- | >1.5- | >0.5-<2 | =<25 | NR |
| | | | | pentane | <4 | | | |
| 17A5 | NR | =>50 | NR | NR | >1.5- | >0.5-<1.5 | =<25 | NR |
| | | | | | <4 | | | |
| 17A6 | NR | =>50 | NR | n- | >1.5- | >0.5-<1.5 | =<25 | NR |
| | | | | pentane | <4 | | | |
| 17A7 | NR | =>50 | NR | NR | >1.5- | >0.5-<2 | =<25 | NR |
| | | | | | <3 | | | |
| 17A8 | NR | =>50 | NR | n- | >1.5- | >0.5-<2 | =<25 | NR |
| | | | | pentane | <3 | | | |
| 17A9 | NR | =>50 | NR | NR | >1.5- | >1-<1.5 | =<25 | NR |
| | | | | | <3 | | | |
| 17A10 | NR | =>50 | NR | n- | >1.5- | >1-<1.5 | =<25 | NR |
| | | | | pentane | <3 | | | |
| 18A1 | NR | =>75 | NR | NR | >1- | >0.5-<2 | =<25 | NR |
| | | | | | <4 | | | |
| 18A2 | NR | =>75 | NR | n- | >1- | >0.5-<2 | =<25 | NR |
| | | | | pentane | <4 | | | |
| 18A3 | NR | =>75 | NR | NR | >1.5- | >0.5-<2 | =<25 | NR |
| | | | | | <4 | | | |
| 18A4 | NR | =>75 | NR | n- | >1.5- | >0.5-<2 | =<25 | NR |
| | | | | pentane | <4 | | | |
| 18A5 | NR | =>75 | NR | NR | >1.5- | >0.5-<1.5 | =<25 | NR |
| | | | | | <4 | | | |
| 18A6 | NR | =>75 | NR | n- | >1.5- | >0.5-<1.5 | =<25 | NR |
| | | | | pentane | <4 | | | |
| 18A7 | NR | =>75 | NR | NR | >1.5- | >0.5-<2 | =<25 | NR |
| | | | | | <3 | | | |
| 18A8 | NR | =>75 | NR | n- | >1.5- | >0.5-<2 | =<25 | NR |
| | | | | pentane | <3 | | | |
| 18A9 | NR | =>75 | NR | NR | >1.5- | >1-<1.5 | =<25 | NR |
| | | | | | <3 | | | |
| 18A10 | NR | =>75 | NR | n- | >1.5- | >1-<1.5 | =<25 | NR |
| | | | | pentane | <3 | | | |
| 19A1 | NR | =>85 | NR | NR | >1- | >0.5-<2 | =<25 | NR |
| | | | | | <4 | | | |
| 19A2 | NR | =>85 | NR | n- | >1- | >0.5-<2 | =<25 | NR |
| | | | | pentane | <4 | | | |
| 19A3 | NR | =>85 | NR | NR | >1.5- | >0.5-<2 | =<25 | NR |
| | | | | | <4 | | | |
| 19A4 | NR | =>85 | NR | n- | >1.5- | >0.5-<2 | =<25 | NR |
| | | | | pentane | <4 | | | |
| 19A5 | NR | =>85 | NR | NR | >1.5- | >0.5-<1.5 | =<25 | NR |
| | | | | | <4 | | | |
| 19A6 | NR | =>85 | NR | n- | >1.5- | >0.5-<1.5 | =<25 | NR |
| | | | | pentane | <4 | | | |
| 19A7 | NR | =>85 | NR | NR | >1.5- | >0.5-<2 | =<25 | NR |
| | | | | | <3 | | | |
| 19A8 | NR | =>85 | NR | n- | >1.5- | >0.5-<2 | =<25 | NR |
| | | | | pentane | <3 | | | |
| 19A9 | NR | =>85 | NR | NR | >1.5- | >1-<1.5 | =<25 | NR |
| | | | | | <3 | | | |
| 19A10 | NR | =>85 | NR | n- | >1.5- | >1-<1.5 | =<25 | NR |
| | | | | pentane | <3 | | | |
| 20A1 | NR | =>95 | NR | NR | >1- | >0.5-<2 | =<25 | NR |
| | | | | | <4 | | | |
| 20A2 | NR | =>95 | NR | n- | >1- | >0.5-<2 | =<25 | NR |
| | | | | pentane | <4 | | | |
| 20A3 | NR | =>95 | NR | NR | >1.5- | >0.5-<2 | =<25 | NR |
| | | | | | <4 | | | |
| 20A4 | NR | =>95 | NR | n- | >1.5- | >0.5-<2 | =<25 | NR |
| | | | | pentane | <4 | | | |
| 20A5 | NR | =>95 | NR | NR | >1.5- | >0.5-<1.5 | =<25 | NR |
| | | | | | <4 | | | |
| 20A6 | NR | =>95 | NR | n- | >1.5- | >0.5-<1.5 | =<25 | NR |
| | | | | pentane | <4 | | | |
| 20A7 | NR | =>95 | NR | NR | >1.5- | >0.5-<2 | =<25 | NR |
| | | | | | <3 | | | |
| 20A8 | NR | =>95 | NR | n- | >1.5- | >0.5-<2 | =<25 | NR |
| | | | | pentane | <3 | | | |
| 20A9 | NR | =>95 | NR | NR | >1.5- | >1-<1.5 | =<25 | NR |
| | | | | | <3 | | | |
| 20A10 | NR | =>95 | NR | n- | >1.5- | >1-<1.5 | =<25 | NR |
| | | | | pentane | <3 | | | |
| 21A1 | NR | =>99 | NR | NR | >1- | >0.5-<2 | =<25 | NR |
| | | | | | <4 | | | |
| 21A2 | NR | =>99 | NR | n- | >1- | >0.5-<2 | =<25 | NR |
| | | | | pentane | <4 | | | |
| 21A3 | NR | =>99 | NR | NR | >1.5- | >0.5-<2 | =<25 | NR |
| | | | | | <4 | | | |
| 21A4 | NR | =>99 | NR | n- | >1.5- | >0.5-<2 | =<25 | NR |
| | | | | pentane | <4 | | | |
| 21A5 | NR | =>99 | NR | NR | >1.5- | >0.5-<1.5 | =<25 | NR |
| | | | | | <4 | | | |
| 21A6 | NR | =>99 | NR | n- | >1.5- | >0.5-<1.5 | =<25 | NR |
| | | | | pentane | <4 | | | |
| 21A7 | NR | =>99 | NR | NR | >1.5- | >0.5-<2 | =<25 | NR |
| | | | | | <3 | | | |
| 21A8 | NR | =>99 | NR | n- | >1.5- | >0.5-<2 | =<25 | NR |
| | | | | pentane | <3 | | | |
| 21A9 | NR | =>99 | NR | NR | >1.5- | >1-<1.5 | =<25 | NR |
| | | | | | <3 | | | |
| 21A10 | NR | =>99 | NR | n- | >1.5- | >1-<1.5 | =<25 | NR |
| | | | | pentane | <3 | | | |
| 22A1 | =>2- | =>50 | NR | NR | >1- | >0.5-<2 | =<25 | NR |
| | =<28 | | | | <4 | | | |
| 22A2 | =>2- | =>50 | NR | n- | >1- | >0.5-<2 | =<25 | NR |
| | =<28 | | | pentane | <4 | | | |
| 22A3 | =>2- | =>50 | NR | NR | >1.5- | >0.5-<2 | =<25 | NR |
| | =<28 | | | | <4 | | | |
| 22A4 | =>2- | =>50 | NR | n- | >1.5- | >0.5-<2 | =<25 | NR |
| | =<28 | | | pentane | <4 | | | |
| 22A5 | =>2- | =>50 | NR | NR | >1.5- | >0.5-<1.5 | =<25 | NR |
| | =<28 | | | | <4 | | | |
| 22A6 | =>2- | =>50 | NR | n- | >1.5- | >0.5-<1.5 | =<25 | NR |
| | =<28 | | | pentane | <4 | | | |
| 22A7 | =>2- | =>50 | NR | NR | >1.5- | >0.5-<2 | =<25 | NR |
| | =<28 | | | | <3 | | | |
| 22A8 | =>2- | =>50 | NR | n- | >1.5- | >0.5-<2 | =<25 | NR |
| | =<28 | | | pentane | <3 | | | |
| 22A9 | =>2- | =>50 | NR | NR | >1.5- | >1-<1.5 | =<25 | NR |
| | =<28 | | | | <3 | | | |
| 22A10 | =>2- | =>50 | NR | n- | >1.5- | >1-<1.5 | =<25 | NR |
| | =<28 | | | pentane | <3 | | | |
| 23A1 | =>2- | =>75 | NR | NR | >1- | >0.5-<2 | =<25 | NR |
| | =<28 | | | | <4 | | | |
| 23A2 | =>2- | =>75 | NR | n- | >1- | >0.5-<2 | =<25 | NR |
| | =<28 | | | pentane | <4 | | | |
| 23A3 | =>2- | =>75 | NR | NR | >1.5- | >0.5-<2 | =<25 | NR |
| | =<28 | | | | <4 | | | |
| 23A4 | =>2- | =>75 | NR | n- | >1.5- | >0.5-<2 | =<25 | NR |
| | =<28 | | | pentane | <4 | | | |
| 23A5 | =>2- | =>75 | NR | NR | >1.5- | >0.5-<1.5 | =<25 | NR |
| | =<28 | | | | <4 | | | |
| 23A6 | =>2- | =>75 | NR | n- | >1.5- | >0.5-<1.5 | =<25 | NR |
| | =<28 | | | pentane | <4 | | | |
| 23A7 | =>2- | =>75 | NR | NR | >1.5- | >0.5-<2 | =<25 | NR |
| | =<28 | | | | <3 | | | |
| 23A8 | =>2- | =>75 | NR | n- | >1.5- | >0.5-<2 | =<25 | NR |
| | =<28 | | | pentane | <3 | | | |
| 23A9 | =>2- | =>75 | NR | NR | >1.5- | >1-<1.5 | =<25 | NR |
| | =<28 | | | | <3 | | | |
| 23A10 | =>2- | =>75 | NR | n- | >1.5- | >1-<1.5 | =<25 | NR |
| | =<28 | | | pentane | <3 | | | |
| 24A1 | =>2- | =>85 | NR | NR | >1- | >0.5-<2 | =<25 | NR |
| | =<28 | | | | <4 | | | |
| 24A2 | =>2. | =>85 | NR | n- | >1- | >0.5-<2 | =<25 | NR |
| | =<28 | | | pentane | <4 | | | |
| 24A3 | =>2- | =>85 | NR | NR | >1.5- | >0.5-<2 | =<25 | NR |
| | =<28 | | | | <4 | | | |
| 24A4 | =>2- | =>85 | NR | n- | >1.5- | >0.5-<2 | =<25 | NR |
| | =<28 | | | pentane | <4 | | | |
| 24A5 | =>2- | =>85 | NR | NR | >1.5- | >0.5-<1.5 | =<25 | NR |
| | =<28 | | | | <4 | | | |
| 24A6 | =>2- | =>85 | NR | n- | >1.5- | >0.5-<1.5 | =<25 | NR |
| | =<28 | | | pentane | <4 | | | |
| 24A7 | =>2- | =>85 | NR | NR | >1.5- | >0.5-<2 | =<25 | NR |
| | =<28 | | | | <3 | | | |
| 24A8 | =>2- | =>85 | NR | n- | >1.5- | >0.5-<2 | =<25 | NR |
| | =<28 | | | pentane | <3 | | | |
| 24A9 | =>2- | =>85 | NR | NR | >1.5- | >1-<1.5 | =<25 | NR |
| | =<28 | | | | <3 | | | |
| 24A10 | =>2- | =>85 | NR | n- | >1.5- | >1-<1.5 | =<25 | NR |
| | =<28 | | | pentane | <3 | | | |
| 25A1 | =>2- | =>95 | NR | NR | >1- | >0.5-<2 | =<25 | NR |
| | =<28 | | | | <4 | | | |
| 25A2 | =>2- | =>95 | NR | n- | >1- | >0.5-<2 | =<25 | NR |
| | =<28 | | | pentane | <4 | | | |
| 25A3 | =>2- | =>95 | NR | NR | >1.5- | >0.5-<2 | =<25 | NR |
| | =<28 | | | | <4 | | | |
| 25A4 | =>2- | =>95 | NR | n- | >1.5- | >0.5-<2 | =<25 | NR |
| | =<28 | | | pentane | <4 | | | |
| 25A5 | =>2- | =>95 | NR | NR | >1.5- | >0.5-<1.5 | =<25 | NR |
| | =<28 | | | | <4 | | | |
| 25A6 | =>2- | =>95 | NR | n- | >1.5- | >0.5-<1.5 | =<25 | NR |
| | =<28 | | | pentane | <4 | | | |
| 25A7 | =>2- | =>95 | NR | NR | >1.5- | >0.5-<2 | =<25 | NR |
| | =<28 | | | | <3 | | | |
| 25A8 | =>2- | =>95 | NR | n- | >1.5- | >0.5-<2 | =<25 | NR |
| | =<28 | | | pentane | <3 | | | |
| 25A9 | =>2- | =>95 | NR | NR | >1.5- | >1-<1.5 | =<25 | NR |
| | =<28 | | | | <3 | | | |
| 25A10 | =>2- | =>95 | NR | n- | >1.5- | >1-<1.5 | =<25 | NR |
| | =<28 | | | pentane | <3 | | | |
| 26A1 | =>2- | =>99 | NR | NR | >1- | >0.5-<2 | =<25 | NR |
| | =<28 | | | | <4 | | | |
| 26A2 | =>2- | =>99 | NR | n- | >1- | >0.5-<2 | =<25 | NR |
| | =<28 | | | pentane | <4 | | | |
| 26A3 | =>2- | =>99 | NR | NR | >1.5- | >0.5-<2 | =<25 | NR |
| | =<28 | | | | <4 | | | |
| 26A4 | =>2- | =>99 | NR | n- | >1.5- | >0.5-<2 | =<25 | NR |
| | =<28 | | | pentane | <4 | | | |
| 26A5 | =>2- | =>99 | NR | NR | >1.5- | >0.5-<1.5 | =<25 | NR |
| | =<28 | | | | <4 | | | |
| 26A6 | =>2- | =>99 | NR | n- | >1.5- | >0.5-<1.5 | =<25 | NR |
| | =<28 | | | pentane | <4 | | | |
| 26A7 | =>2- | =>99 | NR | NR | >1.5- | >0.5-<2 | =<25 | NR |
| | =<28 | | | | <3 | | | |
| 26A8 | =>2- | =>99 | NR | n- | >1.5- | >0.5-<2 | =<25 | NR |
| | =<28 | | | pentane | <3 | | | |
| 26A9 | =>2- | =>99 | NR | NR | >1.5- | >1-<1.5 | =<25 | NR |
| | =<28 | | | | <3 | | | |
| 26A10 | =>2- | =>99 | NR | n- | >1.5- | >1-<1.5 | =<25 | NR |
| | =<28 | | | pentane | <3 | | | |
| 27A1 | =>2- | =>50 | NR | NR | >1- | >0.5-<2 | =<25 | NR |
| | =<10 | | | | <4 | | | |
| 272 | =>2- | =>50 | NR | n- | >1- | >0.5-<2 | =<25 | NR |
| | =<10 | | | pentane | <4 | | | |
| 27A3 | =>2- | =>50 | NR | NR | >1.5- | >0.5-<2 | =<25 | NR |
| | =<10 | | | | <4 | | | |
| 27A4 | =>2- | =>50 | NR | n- | >1.5- | >0.5-<2 | =<25 | NR |
| | =<10 | | | pentane | <4 | | | |
| 27A5 | =>2- | =>50 | NR | NR | >1.5- | >0.5-<1.5 | =<25 | NR |
| | =<10 | | | | <4 | | | |
| 27A6 | =>2- | =>50 | NR | n- | >1.5- | >0.5-<1.5 | =<25 | NR |
| | =<10 | | | pentane | <4 | | | |
| 27A7 | =>2- | =>50 | NR | NR | >1.5- | >0.5-<2 | =<25 | NR |
| | =<10 | | | | <3 | | | |
| 27A8 | =>2- | =>50 | NR | n- | >1.5- | >0.5-<2 | =<25 | NR |
| | =<10 | | | pentane | <3 | | | |
| 27A9 | =>2- | =>50 | NR | NR | >1.5- | >1-<1.5 | =<25 | NR |
| | =<10 | | | | <3 | | | |
| 27A10 | =>2- | =>50 | NR | n- | >1.5- | >1-<1.5 | =<25 | NR |
| | =<10 | | | pentane | <3 | | | |
| 28A1 | =>2- | =>75 | NR | NR | >1- | >0.5-<2 | =<25 | NR |
| | =<10 | | | | <4 | | | |
| 28A2 | =>2- | =>75 | NR | n- | >1- | >0.5-<2 | =<25 | NR |
| | =<10 | | | pentane | <4 | | | |
| 28A3 | =>2- | =>75 | NR | NR | >1.5- | >0.5-<2 | =<25 | NR |
| | =<10 | | | | <4 | | | |
| 28A4 | =>2- | =>75 | NR | n- | >1.5- | >0.5-<2 | =<25 | NR |
| | =<10 | | | pentane | <4 | | | |
| 28A5 | =>2- | =>75 | NR | NR | >1.5- | >0.5-<1.5 | =<25 | NR |
| | =<10 | | | | <4 | | | |
| 28A6 | =>2- | =>75 | NR | n- | >1.5- | >0.5-<1.5 | =<25 | NR |
| | =<10 | | | pentane | <4 | | | |
| 28A7 | =>2- | =>75 | NR | NR | >1.5- | >0.5-<2 | =<25 | NR |
| | =<10 | | | | <3 | | | |
| 28A8 | =>2- | =>75 | NR | n- | >1.5- | >0.5-<2 | =<25 | NR |
| | =<10 | | | pentane | <3 | | | |
| 28A9 | =>2- | =>75 | NR | NR | >1.5- | >1-<1.5 | =<25 | NR |
| | =<10 | | | | <3 | | | |
| 28A10 | =>2- | =>75 | NR | n- | >1.5- | >1-<1.5 | =<25 | NR |
| | =<10 | | | pentane | <3 | | | |
| 29A1 | =>2- | =>85 | NR | NR | >1- | >0.5-<2 | =<25 | NR |
| | =<10 | | | | <4 | | | |
| 29A2 | =>2- | =>85 | NR | n- | >1- | >0.5-<2 | =<25 | NR |
| | =<10 | | | pentane | <4 | | | |
| 29A3 | =>2- | =>85 | NR | NR | >1.5- | >0.5-<2 | =<25 | NR |
| | =<10 | | | | <4 | | | |
| 29A4 | =>2- | =>85 | NR | n- | >1.5- | >0.5-<2 | =<25 | NR |
| | =<10 | | | pentane | <4 | | | |
| 29A5 | =>2- | =>85 | NR | NR | >1.5- | >0.5-<1.5 | =<25 | NR |
| | =<10 | | | | <4 | | | |
| 29A6 | =>2- | =>85 | NR | n- | >1.5- | >0.5-<1.5 | =<25 | NR |
| | =<10 | | | pentane | <4 | | | |
| 29A7 | =>2- | =>85 | NR | NR | >1.5- | >0.5-<2 | =<25 | NR |
| | =<10 | | | | <3 | | | |
| 29A8 | =>2- | =>85 | NR | n- | >1.5- | >0.5-<2 | =<25 | NR |
| | =<10 | | | pentane | <3 | | | |
| 29A9 | =>2- | =>85 | NR | NR | >1.5- | >1-<1.5 | =<25 | NR |
| | =<10 | | | | <3 | | | |
| 29A10 | =>2- | =>85 | NR | n- | >1.5- | >1-<1.5 | =<25 | NR |
| | =<10 | | | pentane | <3 | | | |
| 30A1 | =>2- | =>95 | NR | NR | >1- | >0.5-<2 | =<25 | NR |
| | =<10 | | | | <4 | | | |
| 30A2 | =>2- | =>95 | NR | n- | >1- | >0.5-<2 | =<25 | NR |
| | =<10 | | | pentane | <4 | | | |
| 30A3 | =>2- | =>95 | NR | NR | >1.5- | >0.5-<2 | =<25 | NR |
| | =<10 | | | | <4 | | | |
| 30A4 | =>2- | =>95 | NR | n- | >1.5- | >0.5-<2 | =<25 | NR |
| | =<10 | | | pentane | <4 | | | |
| 30A5 | =>2- | =>95 | NR | NR | >1.5- | >0.5-<1.5 | =<25 | NR |
| | =<10 | | | | <4 | | | |
| 30A6 | =>2- | =>95 | NR | n- | >1.5- | >0.5-<1.5 | =<25 | NR |
| | =<10 | | | pentane | <4 | | | |
| 30A7 | =>2- | =>95 | NR | NR | >1.5- | >0.5-<2 | =<25 | NR |
| | =<10 | | | | <3 | | | |
| 30A8 | =>2- | =>95 | NR | n- | >1.5- | >0.5-<2 | =<25 | NR |
| | =<10 | | | pentane | <3 | | | |
| 30A9 | =>2- | =>95 | NR | NR | >1.5- | >1-<1.5 | =<25 | NR |
| | =<10 | | | | <3 | | | |
| 30A10 | =>2- | =>95 | NR | n- | >1.5- | >1-<1.5 | =<25 | NR |
| | =<10 | | | pentane | <3 | | | |
| 31A1 | =>2- | =>99 | NR | NR | >1- | >0.5-<2 | =<25 | NR |
| | =<10 | | | | <4 | | | |
| 31A2 | =>2- | =>99 | NR | n- | >1- | >0.5-<2 | =<25 | NR |
| | =<10 | | | pentane | <4 | | | |
| 31A3 | =>2- | =>99 | NR | NR | >1.5- | >0.5-<2 | =<25 | NR |
| | =<10 | | | | <4 | | | |
| 31A4 | =>2- | =>99 | NR | n- | >1.5- | >0.5-<2 | =<25 | NR |
| | =<10 | | | pentane | <4 | | | |
| 31A5 | =>2- | =>99 | NR | NR | >1.5- | >0.5-<1.5 | =<25 | NR |
| | =<10 | | | | <4 | | | |
| 31A6 | =>2- | =>99 | NR | n- | >1.5- | >0.5-<1.5 | =<25 | NR |
| | =<10 | | | pentane | <4 | | | |
| 31A7 | =>2- | =>99 | NR | NR | >1.5- | >0.5-<2 | =<25 | NR |
| | =<10 | | | | <3 | | | |
| 31A8 | =>2- | =>99 | NR | n- | >1.5- | >0.5-<2 | =<25 | NR |
| | =<10 | | | pentane | <3 | | | |
| 31A9 | =>2- | =>99 | NR | NR | >1.5- | >1-<1.5 | =<25 | NR |
| | =<10 | | | | <3 | | | |
| 31A10 | =>2- | =>99 | NR | n- | >1.5- | >1-<1.5 | =<25 | NR |
| | =<10 | | | pentane | <3 | | | |

### Methods

The methods of the present invention, including each of Foam Forming Methods 1-3, utilize a thermoplastic composition in which at least about 60% by weight of the thermoplastic is polystyrene. For the purposes of convenience, foam forming methods in accordance with this paragraph are referred to herein as Foam Forming Method 4A.

The methods of the present invention, including each of Foam Forming Methods 1-3, utilize a thermoplastic composition in which at least about 70% by weight of the thermoplastic is polystyrene. For the purposes of convenience, foam forming methods in accordance with this paragraph are referred to herein as Foam Forming Method 4B.

The methods of the present invention, including each of Foam Forming Methods 1-3, utilize a thermoplastic composition in which at least about 80% by weight of the thermoplastic is polystyrene. For the purposes of convenience, foam forming methods in accordance with this paragraph are referred to herein as Foam Forming Method 4C.

The methods of the present invention, including each of Foam Forming Methods 1-3, utilize a thermoplastic composition in which at least about 90% by weight of the thermoplastic is polystyrene. For the purposes of convenience, foam forming methods in accordance with this paragraph are referred to herein as Foam Forming Method 4D.

The methods of the present invention, including each of Foam Forming Methods 1-3, utilize a thermoplastic composition in which at least about 95% by weight of the thermoplastic is polystyrene. For the purposes of convenience, foam forming methods in accordance with this paragraph are referred to herein as Foam Forming Method 4E.

The methods of the present invention, including each of Foam Forming Methods 1-3, utilize a thermoplastic composition in which at least about 99% by weight of the thermoplastic is polystyrene. For the purposes of convenience, foam forming methods in accordance with this paragraph are referred to herein as Foam Forming Method 4F.

The methods of the present invention, including each of Foam Forming Methods 1-3, utilize a thermoplastic composition which consists essentially of polystyrene. For the purposes of convenience, foam forming methods in accordance with this paragraph are referred to herein as Foam Forming Method 4G.

The methods of the present invention, including each of Foam Forming Methods 1-3, utilize a thermoplastic composition which consists of polystyrene. For the purposes of convenience, foam forming methods in accordance with this paragraph are referred to herein as Foam Forming Method 4H.

The methods of the present invention include foam forming methods in which each of Expandable Pellets 1-16 are expanded and used to form a thermoplastic foam. For the purposes of convenience, foam forming methods in accordance with this paragraph are referred to herein as Foam Forming Method 5A.

The methods of the present invention include foam forming methods in which each of Expandable Pellets 1-16 are expanded and used to form a molded thermoplastic foam. For the purposes of convenience, foam forming methods in accordance with this paragraph are referred to herein as Foam Forming Method 5B.

The methods of the present invention include foam forming methods in which each of Expanded Pellets 1-31 are joined to form a thermoplastic foam. For the purposes of convenience, foam forming methods in accordance with this paragraph are referred to herein as Foam Forming Method 6A.

The methods of the present invention include foam forming methods in which each of Expandable Pellets 1-31 are joined by molding to form a molded thermoplastic foam. For the purposes of convenience, foam forming methods in accordance with this paragraph are referred to herein as Foam Forming Method 6B.

The methods of the present invention include foam forming methods which produce a foam of the present invention, including each of Foams 1-31 by joining thermoplastic pellets to form a thermoplastic foam. For the purposes of convenience, foam forming methods in accordance with this paragraph are referred to herein as Foam Forming Method 7A.

The methods of the present invention include foam forming methods which produce a foam of the present invention, including each of Foams 1-31 by joining thermoplastic pellets in a mold to form a thermoplastic foam. For the purposes of convenience, foam forming methods in accordance with this paragraph are referred to herein as Foam Forming Method 7B.

### EXAMPLES

The following examples are provided for the purpose of illustrating the present invention but without limiting the scope thereof.

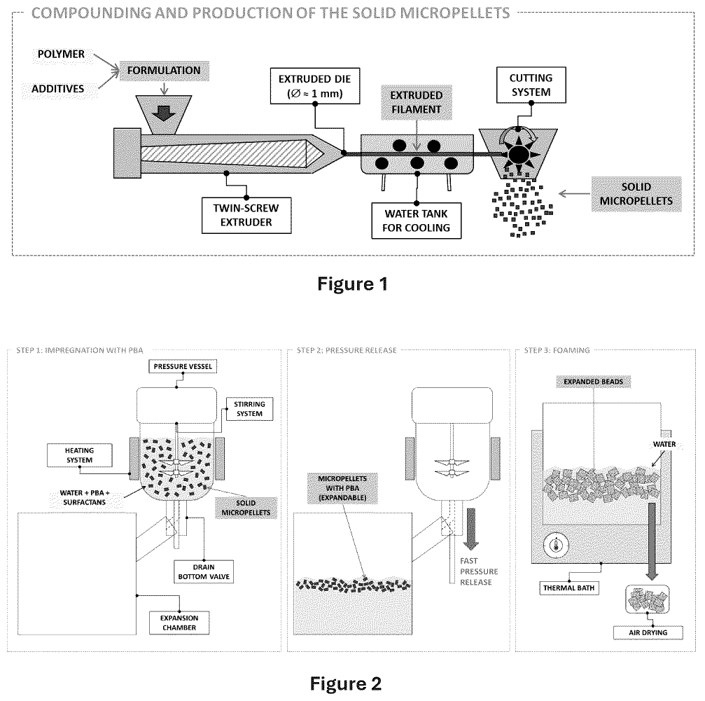

The examples which followed each utilized as the starting polystyrene particles product made in accordance with the procedure described below and as illustrated in FIG. 1.

Polystyrene
Styron 660

The starting polymer used to create the resin formulation feeding the twin screw extruder was polystyrene available under the tradename Styron 660 from Trinesco having the following properties:

| | Value | Unit | Test Standard |
|---|---|---|---|
| Processing/Physical | | | |
| Characteristics | | | |
| Iso Data | | | |
| Melt flow index, | 7 | g/10 min | ISO 1133 |
| MFI | | | |
| Temperature | 200 | ° C. | |
| Load | 5 | kg | |
| Mechanical | | | |
| Properties | | | |
| Iso Data | | | |
| Yield Stress | 40 | MPa | ISO 527 |
| Strain at break | 2 | % | ISO 527 |
| Flexural modulus, | 3300 | MPa | ISO 178 |
| 23° C. | | | |
| Rockwell hardness | R105 | — | ISO 2039-2 |
| Thermal Properties | | | |
| Iso Data | | | |
| Vicat softening | 107 | ° C. | ISO 306 |
| temperature, A | | | |
| Vicat softening | 100 | ° C. | ISO 306 |
| temperature, B | | | |

The screw speed used in the extruder was 40 revolutions per minute, and the temperature profile in the extruder was, based on temperature reading evenly spaced along the barrel of the screw from about the formulation introduction end to the die was 145° C., 155° C., 165° C., 175° C. and 185° C. Solid pellets are produced in a general disc shape having a diameter of about 1 mm.

The pellets produced as described above were then introduced into a stirred tank pressure vessel to produce expandable pellets and then expandable into an expansion tank to form expanded pellets using equipment generally as illustrated in FIG. 2 and described below.

In an initial step of the impregnation process, the pellets of polystyrene are added to a heated bath contained in a lab-scale pressure vessel equipped with a stirrer. The bath consisted of water, surfactants in an amount to help reduce sticking/agglomeration of the pellets and then the physical blowing agent (sometimes referred to in these examples as PBA) reported for each example below were added under ambient pressure since the blowing agents are liquids at ambient pressure. In each of the experiments, the total weight of the pellets in the bath is set to 40 grams and the total volume of PBA is set to 10 ml. The micro-pellets are maintained in the bath at a temperature of about 40° C. for 24 hours with continuous stirring. After the 24 hour impregnation step, any pressure increase that has occurred in the vessel during the process is quickly released and the liquid bath together with the impregnated pellets are transported to an expansion chamber equipped with a heater. A three (3) gram sample of the impregnated beads leaving the pressure vessel are obtained and subject to gas chromatography (GC) to determine the total amount of PMA in the pellets and the relative amount of each component in the PBA, as described below. The pellets as they leave the pressure vessel are referred to in the examples as “Expandable Pellets.”

Water is then added to the expansion chamber in an amount sufficient to immerse the Expandable Pellets and then the temperature of the bath is raised to about 40° C. for about 24 hours, thereby allowing the pellets to undergo an expansion under ambient pressure to produce expanded pellets. The expanded pellets are then air dried. The dry, expanded pellets (referred to hereinafter as “Expanded Pellets”) are tested as initially formed and are then stored at the indicated temperature for 13 days, with samples of the particles after storage to determine the total amount of PBA contained in the Expanded Pellets, the relative amount of each component of the PBA which remains contained in the particles, and the density of the particles.

The CG was conducted using a gas chromatograph 7890N with a HP-5 MS column (30 m×250 μm×0.25 μm) with a Head Space system for sampling and an FID detector. To quantify the total amount of PBA and the relative amount of each PBA component in the gas, calibration lines for each component are first prepared. The bead sample is then heated to 120° C. to melt the polymer and allow total release of the PBAs. The conditions used in the GC process are reported in the table below.

| INJECTION | Injection type | | Head Space (HS) |
|---|---|---|---|
| Incubation | 120° | C. | |
| temperature | | | |
| Desorption time | 10 | min | |
| Injection volume | 0.5 | mL | |
| Injector type | Split | | |
| Split conditions | 1/50 | | |
| COLUMN | Name and dimensions | | HP 5MS (30 m × 250 |
| | | | μm × 0.25 μm) |
| Mobile phase | Helium | | |
| Mobile phase flux | 1.0 | mL/min | |

| | | |
|---|---|---|
| Separation type | Gas liquid chromatography | |
| | (GLC) | |
| Column | Capillary column (WCOT) | |
| Column content | (5%-phenyl)- | |
| | methylpolisiloxane | |
| OVEN | Oven temperature | 2 min (40° C.) → ΔT = |
| | program | 20° C./min (until 120° |
| | | C.) |
| ANALYSIS | Analysis time | 5 min |
| Detector | Flame ionization detector | |
| | (FID) | |

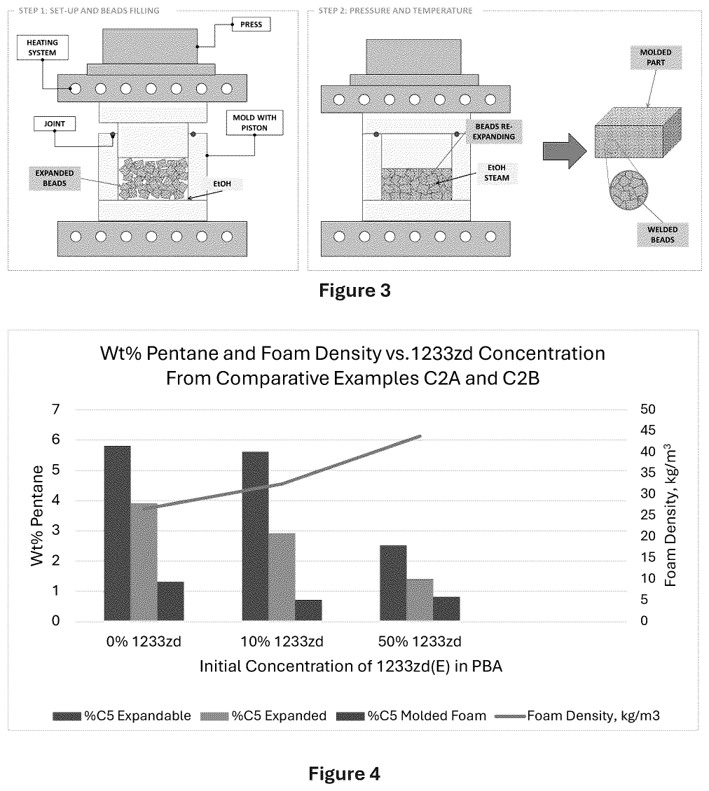

After the 13 day storage period, the Expanded Pellets produced as described above are introduced into a lab-scale mold which is designed to be representative on a comparative basis of commercial steam chest molding, except using ethanol vapor in the mold instead of steam. The equipment used and process steps taken to produce the molded foam are summarized below in connection with the steps as illustrated in FIG. 3.

The mold is charged with ethanol to form an ethanol vapor space surrounding the beads, and then the Expanded Pellets are charged to the mold. The mold is closed, heated to and maintained at a predefined temperature for a predefined time to produce the foam.

The molded foam thus produced is then sampled to determine the foam density and thermal conductivity. The thermal conductivity is measured as reported in Sánchez-Calderón, B. Merillas, V. Bernardo, M. Á. Rodríguez-Pérez, Methodology for measuring the thermal conductivity of insulating samples with small dimensions by heat flow meter technique, J. Therm. Anal. Calorim. (2022). (see https://doi.org/10.1007/s10973-022-11457-7).

### Comparative Example C1¹—Impregnated Beads, Expanded Beads and Molded Foam from PBA Consisting of N-Pentane

¹ The designation as the Examples hereof as “comparative” is not a concession that the example represents an item of prior art. Instead, the use of the term “comparative” for an example is an indication only that the results of testing done by applicant indicate that the performance according to the example are less favorable in some respect than the aspects of the invention which are illustrated by testing done by applicant and reported as an “example” of the invention.

In Comparative Example C1, the beads are impregnated with blowing agent consisting of n-pentane, expanded beads are formed and the expanded beads are molded into foam using the equipment and materials as described and illustrated above. The results of this test are reported in Table ExC1 below:

TABLE ExC1

| | EXPANDABLE | EXPANDED | MOLDED |
|---|---|---|---|
| | PELLETS | PELLETS | FOAM |
| PBA AMOUNTS | | | |
| Wt. % of n-pentane | 5.5 | 2.3 | 0.5 |
| Wt. % of 1233zd(E) | 0 | 0 | 0 |
| Total Wt. % of PBA | 5.5 | 2.3 | 0.5 |
| PELLET | | | |
| PROPERTY | | | |
| Expanded Pellet | NA | 49.1 | NA |
| Density, kg/m3 | | | |
| FOAM | | | |
| PROPERTIES | | | |
| Density, kg/m3 | NA | NA | 26.5 |
| Thermal | NA | NA | 33.8 |
| Conductivity, | | | |
| mW/mK | | | |

The above results above show base-line foam performance using n-pentane as the sole PBA.

### Comparative Examples C2A and C2B—Impregnated Beads, Expanded Beads and Molded Foam from PBA Consisting of 90% N-Pentane And 10% 1233zd(E) and with 50% N-Pentane and 50% 1233zd(E)

Comparative Example 1 is repeated, except that: (A) for Comparative Example C2A, the PBA used in the impregnation step consists of 90% by weight n-pentane and 10% by weight of HFCO-1233zd(E); and (B) for Comparative Example C2B, the PBA used in the impregnation step consists of 50% by weight n-pentane and 50% by weight of HFCO-1233zd(E). The results of this test are reported in Table ExC2 below and illustrated in FIG. 4, together with the results from Comparative Example 1 for convenience of comparison:

TABLE ExC2

| | EXPANDABLE | | | EXPANDED | | | | | |
|---|---|---|---|---|---|---|---|---|---|
| | PELLETS | | | PELLETS | | | MOLED FOAM | | |
| Example No. | ExC1 | ExC2A | EXC2B | ExC1 | ExC2A | ExC2B | ExC1 | ExC2A | ExC2B |
| PBA AMOUNTS | | | | | | | | | |
| Wt. % of n-pentane | 5.8 | 5.6 | 2.5 | 3.9 | 2.9 | 1.4 | 1.3 | 0.7 | 0.8 |
| Wt. % of 1233zd(E) | 0 | 0.9 | 3.2 | 0 | 0.7 | 1.6 | 0 | 0.5 | 1.0 |
| Total Wt. % of PBA | 5.8 | 6.7 | 5.7 | 3.9 | 3.6 | 3.0 | 1.3 | 1.2 | 1.8 |
| PELLET | | | | | | | | | |
| PROPERTY | | | | | | | | | |
| Expanded Pellet | | | | 49.1 | 48.0 | 56.5 | | | |
| Density, kg/m3 | | | | | | | | | |
| FOAM | | | | | | | | | |
| PROPERTIES | | | | | | | | | |
| Density, kg/m3 | | | | | | | 26.5 | 32.4 | 43.7 |
| Thermal | | | | | | | 33.8 | 34.3 | 31.8 |
| Conductivity, | | | | | | | | | |
| mW/mK | | | | | | | | | |

As can be seen from the data above, applicants have found that the density of expanded foam appears to increase as the amount of 1233zd(E) in the initial PBA used to impregnate the pellets increases based on the results of adding 10% and 50% of HFCO-1233zd(E). This is a highly undesirable result since increased density generally reduces the value of the foam for many applications, including as thermal insulating board foam. Applicant's test data also shows that a reduced concentration of pentane is observed as 1233zd(E) is added to the initial PBA used to impregnate the foam in amounts of 10% and 50% by weight.

Based on the results of these comparative examples, a person skilled in the art would reasonably expect that the density of a molded foam made from a PBA with an initial amount of HFCO-1233zd(E) of greater than 10% and less than 50% would be in the range of from about 32.4% to about 43.7%.

### Example 1—Impregnated Beads, Expanded Beads and Molded Foam from PBA Consisting of 80% N-Pentane and 20% 1233zd(E)

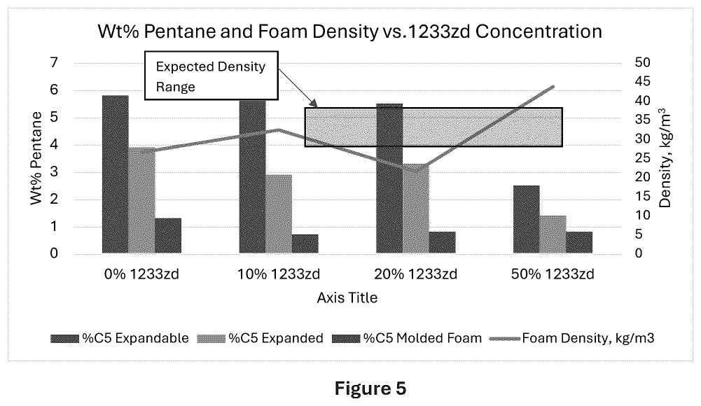

Comparative Example 1 is repeated, except that the PBA used for the impregnation step consists of 80% by weight n-pentane and 20% by weight of HFCO-1233zd(E). The results of this test are reported in Table Ex1 below and illustrated in FIG. 5, together with the results from Comparative Examples 1 and 2 for convenience of comparison:

| | EXPANDABLE | | | | EXPANDED | | | | | | | |
|---|---|---|---|---|---|---|---|---|---|---|---|---|
| | PELLETS | | | | PELLETS | | | | MOLED FOAM | | | |
| Example No. | ExC1 | ExC2A | EXC2B | Ex1 | ExC1 | ExC2A | EXC2B | Ex1 | ExC1 | ExC2A | EXC2B | Ex1 |
| PBA AMOUNTS | | | | | | | | | | | | |
| Wt. % of n-pentane | 5.8 | 5.6 | 2.5 | 5.5 | 3.9 | 2.9 | 1.4 | 3.3 | 1.3 | 0.7 | 10.8 | 2.3 |
| Wt. % of 1233zd(E) | 0 | 0.9 | 3.2 | 1.7 | 0 | 0.7 | 1.6 | 1.2 | 0 | 0.5 | 1.0 | 0.8 |
| Total Wt. % of PBA | 5.8 | 6.7 | 5.7 | 7.7 | 3.9 | 3.6 | 3.0 | 4.5 | 1.3 | 1.2 | 1.8 | 3.1 |
| PELLET PROPERTY | | | | | | | | | | | | |
| Expanded Pellet | | | | | 49.1 | 48.0 | 56.5 | 38.0 | | | | |
| Density, kg/m3 | | | | | | | | | | | | |
| FOAM PROPERTIES | | | | | | | | | | | | |
| Density, kg/m3 | | | | | | | | | 26.5 | 32.4 | 43.7 | 21.5 |
| Thermal Conductivity, | | | | | | | | | 33.8 | 34.3 | 31.8 | 32.4 |
| mW/mK | | | | | | | | | | | | |

As can be seen from applicant's test work above, applicant has found that the use of an initial PBA comprising, consisting essentially of or consisting of pentane and greater than 10% by weight and less than 50% by weight of HFCO-1233zd(E) is able to produce a highly desirable but unexpected result of a foam density that is dramatically below the expected density range based on the 10% and 50% 1233zd(E) results. In particular, the density of the foam made with initial PBA of about 20% has a density that is lower by from about 30 to about 50 relative percent compared to the expected density range. Moreover, the thermal conductivity of the foam made using 20% of 1233zd(E) according to this example is better than Comparative Example 1 (0% 1233zd(E)) and Comparative Example 2A (10% 1233zd(E)) and not significantly higher than the thermal conductivity achieved when the initial PBA contains 50% of 1233zd(E). This combination of unexpectedly low density and low thermal conductivity is highly advantageous.

What is claimed is:

1. A method of making thermoplastic foam comprising:
(a) impregnating a plurality of thermoplastic pellets comprising at least about 50% by weight of polystyrene with a physical blowing agent by:
a. immersing said plurality of pellets in a bath comprising a physical blowing agent to produce a plurality of expandable pellets, said physical blowing agent comprising, based on the total weight of the physical blowing agent in said bath:
i. from greater than about 50% by weight to less than about 90% by weight of pentane; and
ii. from greater than about 10% by weight to less than about 50% by weight of HFCO-1233zd(E);
(b) expanding said expandable pellets to produce expanded pellets; and
(c) forming foam by joining said expanded pellets.

2. The method of claim 1 wherein said forming step comprises introducing said expanded pellets into a mold and molding said expanded pellets into a foam.

3. The method of claim 1 wherein said expanded pellets comprise an amount of pentane on a weight basis that is not more than 20 relative percent less than the amount of pentane present when said process is repeated except using physical blowing agent consisting of said pentane.

4. The method of claim 1 wherein said expandable pellets comprise not less than 5% by weight of said pentane and not less than 1% by weight of HFCO-1233zd(E).

5. The method of claim 1 wherein said expanded pellets comprise not less than 2 percent on a weight basis of said pentane.

6. The method of claim 1 wherein said foam has a density of not greater than 25 kg/m³ and wherein said expanded pellets are stored for a period of at least 13 days before said forming step.

7. The method claim 1 wherein said expanded pellets comprise from greater than 2.5% to about 6.5% by weight of pentane and from greater than 1% by weight to less than about 3% by weight of HFCO-1233zd(E).

8. The method of claim 1 wherein said expanded pellets comprise from greater than 1% by weight to less than about 2% by weight of HFCO-1233zd(E).

9. The method of claim 1 wherein said pentane comprises n-pentane.

10. Expanded thermoplastic pellets comprising:
(a) at least about 50% by weight of polystyrene; and
(b) a physical blowing agent comprising, based on the total weight of the physical blowing agent in said expanded pellets:
i. from greater than 1.5 to about 3.5% by weight of pentane; and
ii. greater than 1% by weight to less than about 2% by weight of HFCO-1233zd(E).

11. The expanded pellets of claim 10 comprising from greater than 2.5% to about 6.5% by weight of pentane.

12. The expanded pellets of claim 1 wherein said pentane comprises n-pentane.

13. The expanded pellets of claim 1 wherein said pentane consists essentially of n-pentane.

14. The expanded pellets of claim 1 wherein said pentane consists of n-pentane.

15. A closed-cell thermoplastic foam comprising:
(a) a plurality of closed cells comprising cell walls formed by a plurality joined thermoplastic pellets, wherein said thermoplastic comprises at least about 50% by weight of polystyrene; and
(b) a physical blowing agent contained within said closed cells and comprising, based on the total weight of the foam:
i. greater than 1.5% by weight of pentane; and
ii. not less than 1% by weight of HFCO-1233zd(E),
wherein said foam has a density of not greater than 40 kg/m³.

16. The foam of claim 15 wherein said pentane comprises n-pentane.

17. The foam of claim 15 wherein said pentane consists essentially of n-pentane.

18. The foam of claim 15 wherein said pentane consists of n-pentane.

19. The foam of claim 15 wherein said foam has a density of not greater than 25 kg/m³.

20. The foam of claim 19 wherein said foam has a thermal conductivity of about 35 mW/mK or less.
